(19) United States
(12) Patent Application Publication
(10) Pub. No.: US 2022/0366474 A1
(43) Pub. Date: Nov. 17, 2022

(54) Systems, Methods, and Environments for Providing Subscription Product Recommendations

(71) Applicant: AON GLOBAL OPERATIONS SE, SINGAPORE BRANCH, Singapore (SG)

(72) Inventors: Geoffrey Kuhn, London (GB); Edward Allen Cwikla, Chicago, IL (US); Andy Rallis, Singapore (SG); Myungki Suh, Singapore (SG); Kartick Subramanian, Singapore (SG); Tay Wei Ru, Singapore (SG)

(73) Assignee: AON GLOBAL OPERATIONS SE, SINGAPORE BRANCH, Singapore (SG)

(21) Appl. No.: 17/744,425

(22) Filed: May 13, 2022

Related U.S. Application Data
(60) Provisional application No. 63/188,730, filed on May 14, 2021.

(51) Int. Cl. G06Q 30/06; G06N 20/00

(52) U.S. Cl. CPC G06Q 30/0631; G06N 20/00

(57) ABSTRACT

In an illustrative embodiment, systems and methods for providing subscription product recommendations can identify, from trained data models, cost-driving factors impacting costs of subscription products offered by a provider. The data models can be trained with claims data from a member population with multiple years of claims data. The cost-driving factors can correspond to attributes of the claims data in a first year that predict future costs in a following year. Requests for product recommendations include responses to questions each associated with a cost-driving factor. Based on the responses, the member can be mapped to a cluster grouping associated with a projected cost to the member for a subscription product. Recommendations can be generated based on an economic equivalent score for each subscription product reflecting the respective projected cost and one or more adjustment factors indicating an impact of one or more qualitative factors on subscription product selection choices.

### RELATED APPLICATIONS

This application claims priority to U.S. Provisional Patent Application Ser. No. 63/188,730, entitled “Systems, Methods, and Environments for Providing Subscription Product Recommendations,” filed May 14, 2021. This application is related to the following prior patent applications: U.S. patent application Ser. No. 15/900,705, now U.S. Pat. No. 10,402,788, entitled “Dashboard Interface, Platform, and Environment for Intelligent Subscription Product Selection,” filed Feb. 20, 2018, and U.S. patent application Ser. No. 16/554,157, now U.S. Pat. No. 10,664,806, entitled “Dashboard Interface, Platform, and Environment for Intelligent Subscription Product Selection,” filed Aug. 28, 2019. All above identified applications are hereby incorporated by reference in their entireties.

### SUMMARY OF ILLUSTRATIVE EMBODIMENTS

The foregoing general description of the illustrative implementations and the following detailed description thereof are merely exemplary aspects of the teachings of this disclosure and are not restrictive.

In certain embodiments, systems and methods for providing subscription product recommendations include one or more computing systems configured to identify, by a set of trained machine learning data models, cost-driving factors impacting costs of a plurality of subscription products offered by a provider. The set of trained machine learning data models can be trained with claims data from a member population having two or more successive years of associated claims data for members of a member population. The one or more cost-driving factors correspond to attributes of the claims data in a first year of the two or more successive years that predict future costs from the claims data in at least one next year of the two or more successive years.

In some embodiments, the system can receive, from a remote computing device of a member via a network, a request for subscription product recommendations offered by the provider, the request including responses to one or more questions each associated with a factor of the one or more cost-driving factors. Based on the responses to the one or more questions, the member can be mapped to a cluster grouping of a plurality of cluster groupings. Each cluster grouping can be defined by one or more member attributes associated with the one or more cost-driving factors, and each cluster grouping can include a projected cost to the member associated with each of the plurality of subscription products. In some embodiments, the system can determine, in real-time based on the mapping of the member to the cluster grouping, one or more subscription product recommendations for the member. The one or more subscription product recommendations can be based on an economic equivalent score for each of the plurality subscription products based on the projected cost for the respective subscription product and one or more adjustment factors indicating an impact of one or more qualitative factors on subscription product selection choices made by the member. The system can cause presentation, in real-time responsive to receiving the request, of a subscription product recommendation user interface screen at the remote computing device that presents the one or more subscription product recommendations for viewing or selection by the member.

### BRIEF DESCRIPTION OF THE DRAWINGS

The accompanying drawings, which are incorporated in and constitute a part of the specification, illustrate one or more embodiments and, together with the description, explain these embodiments. The accompanying drawings have not necessarily been drawn to scale. Any values dimensions illustrated in the accompanying graphs and figures are for illustration purposes only and may or may not represent actual or preferred values or dimensions. Where applicable, some or all features may not be illustrated to assist in the description of underlying features. In the drawings:

FIG. 1 illustrates an example block diagram of an environment for managing recommendations for provision of products between industry participants and individual users;

FIG. 2 illustrates an example flow diagram of processes for managing generation of subscription product recommendation by a benefits administration system;

FIG. 3 illustrates an example workflow diagram of interactions between system components of a benefits administration system;

FIG. 4 illustrates an example diagram of a data architecture for a benefits administration system;

FIG. 5 illustrates an example diagram of a data architecture for a benefits administration system;

FIG. 6 illustrates an example data structure for linking recommendation results to a member identification;

FIG. 7 illustrates an example diagram of recommendation results provided by a benefits administration system;

FIG. 8 illustrates an example flow chart of a subscription product recommendation process;

FIGS. 9A-9C illustrate example portions of flow charts associated with a subscription product recommendation process; and

FIGS. 10-11 illustrate example computing systems on which the processes described herein can be implemented.

### DETAILED DESCRIPTION OF ILLUSTRATIVE EMBODIMENTS

The description set forth below in connection with the appended drawings is intended to be a description of various, illustrative embodiments of the disclosed subject matter. Specific features and functionalities are described in connection with each illustrative embodiment; however, it will be apparent to those skilled in the art that the disclosed embodiments may be practiced without each of those specific features and functionalities.

Reference throughout the specification to “one embodiment” or “an embodiment” means that a particular feature, structure, or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments. Further, it is intended that embodiments of the disclosed subject matter cover modifications and variations thereof.

It must be noted that, as used in the specification and the appended claims, the singular forms “a,” “an,” and “the” include plural referents unless the context expressly dictates otherwise. That is, unless expressly specified otherwise, as used herein the words “a,” “an,” “the,” and the like carry the meaning of “one or more.” Additionally, it is to be understood that terms such as “left,” “right,” “top,” “bottom,” “front,” “rear,” “side,” “height,” “length,” “width,” “upper,” “lower,” “interior,” “exterior,” “inner,” “outer,” and the like that may be used herein merely describe points of reference and do not necessarily limit embodiments of the present disclosure to any particular orientation or configuration. Furthermore, terms such as “first,” “second,” “third,” etc., merely identify one of a number of portions, components, steps, operations, functions, and/or points of reference as disclosed herein, and likewise do not necessarily limit embodiments of the present disclosure to any particular configuration or orientation.

Furthermore, the terms “approximately,” “about,” “proximate,” “minor variation,” and similar terms generally refer to ranges that include the identified value within a margin of 20%, 10% or preferably 5% in certain embodiments, and any values therebetween.

All of the functionalities described in connection with one embodiment are intended to be applicable to the additional embodiments described below except where expressly stated or where the feature or function is incompatible with the additional embodiments. For example, where a given feature or function is expressly described in connection with one embodiment but not expressly mentioned in connection with an alternative embodiment, it should be understood that the inventors intend that that feature or function may be deployed, utilized or implemented in connection with the alternative embodiment unless the feature or function is incompatible with the alternative embodiment.

Aspects of the present disclosure are directed to providing a computerized, predictive support solution for generating subscription product recommendations for subscribers and managing and predicting costs and usage of subscription products. In some embodiments, subscription products can include insurance benefits offered by an employer to its employees such as health insurance benefits. In some implementations, a benefits administration system can use data science training techniques to generate predictive models for determining future costs to subscription product carriers and employers based on current characteristics of a member (employee) population. In one example, each member in the member population can correspond to an employee plus any family member of the employee that are covered under the employee's benefit plan. In some examples, the predictive models can be used to make recommendations to members for plan selection based on projected costs and cost-based behaviors (e.g., how risk averse a given member is regarding a willingness to personally incur out of pocket (OOP) medical expenses). In some implementations, member recommendations can be made in real-time in response to requests submitted to the benefits administration system.

The requests for subscription product recommendations, in some implementations, can include responses to screening questionnaires that are used by the system to classify each member into categorical clusters associated with member medical attributes (drugs or medical treatments currently taken, family planning plans for the future), demographic information, and/or subscription product attributes. In some examples, employers may adjust or remove one or more questions in a questionnaire question set based on a sensitivity level of a question (e.g., whether the member is currently receiving chemotherapy treatments). In situations where questions are removed from a standard set of questions, the benefits administration system, using the data sets and trained models, can backfill any empty question responses with response estimates based on responses made in other questionnaires made by other members. Moreover, in other examples, recommendations can be performed in batches to identify sets of members or potential members to contact for subscription product processing or renewal.

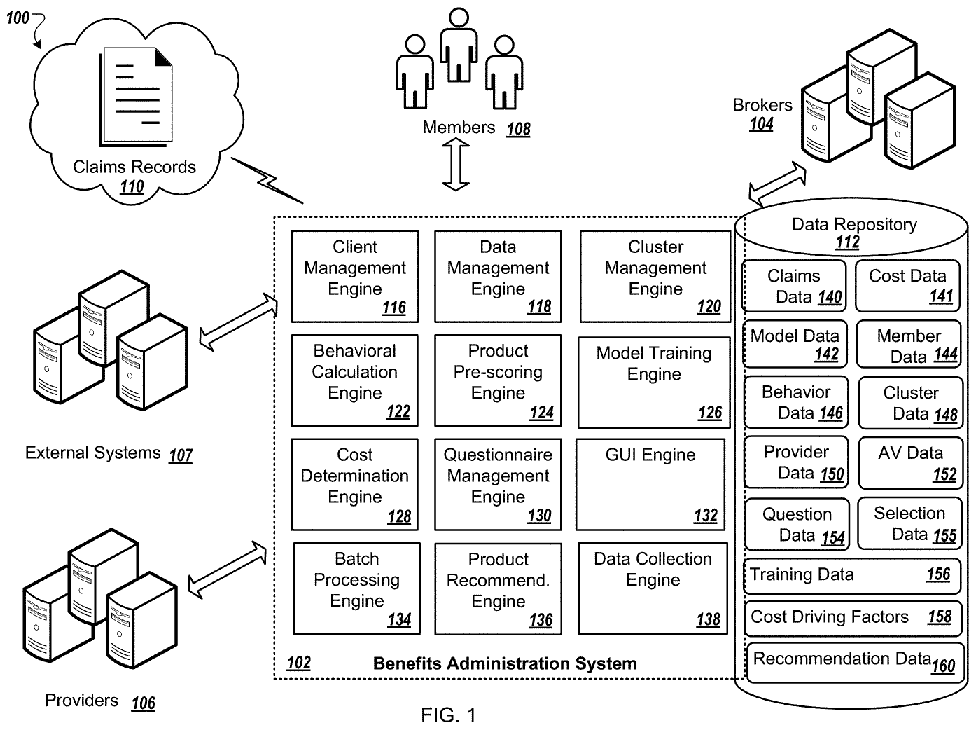

Turning to the figures, FIG. 1 is an example environment 100 for providing subscription product recommendations to members of a subscription product exchange that includes interactions of participants (providers 106, members 108, and brokers 104) with a benefits administration system 102. In some implementations, the product offerings may include health insurance plans that providers 106 (e.g., employers) offer to members 108 (e.g., employees that work for a company or institution that offers health, pharmacy, and other insurance services as a benefit of employment). The members 108 may be referred to interchangeably as employees throughout the disclosure. Further, references to members 108 or employees throughout the disclosure can correspond to an individual employee of a provider 106 or the employee plus any family members covered by a subscription product offered by the provider 106 to the member 108. In some examples, the recommendations may include subscription products offered by a provider that may be most appealing to a member 108 based on willingness to accept risk (e.g., OOP expenses) and projected costs to the member 108 and/or provider 106 based on a likelihood of the member 108 to utilize services under a respective subscription product. In some examples, brokers 106 may include participants who interact with the benefits administration system 102 to load subscription product updates and provide claims data for training customized, predictive data science models for making subscription product recommendations.

In some aspects, the environment 100 may include a number of provider (e.g., client or employer) computing systems 106, a number of member computing systems 108, and a number of broker computing systems 104 in communication with a network-based system 102 providing a variety of software engines 116 through 138 for supporting a platform for managing subscription product administration. In some examples, the computing systems for the providers 106, members 108, and brokers 104 may include individual computing devices, servers, and/or organizational computing systems. In addition, the system 102 manages data in a data repository 112 that is generated and/or accessed when performing the processes associated with providing subscription products to clients described further herein.

In some implementations, the benefits administration system 102 can also interface with additional internal and/or external computing systems 107 that provide additional information and/or data processing capabilities that can be used by the system 102 to generate product recommendations for member 108 that are customized to likely future use of the subscription products by each member 108. In some embodiments, the additional computing systems 107 can include internal or external computing systems that provide claims records 110 to the benefits administration system 102 that can be used by model training engine 126 in training the data models to predict costs incurred by a given member in an upcoming one or more years based on current member characteristics and anticipated claim-related events. In some examples, the claims records 110 can be obtained from subscription product plan vendors such as insurance brokers 104, insurance carriers, or other common data sources that maintain and track claims-related information. In some implementations, upon receiving claims records 110 data management engine 118 may store the claims records 110 as claims data 140 in data repository 112. In some implementations, data collection engine 138 may periodically query computing systems that provide claims records 110. In some aspects, the data collection may continuously monitor the computing systems for claims records updates or may receive claims records 110 automatically submitted by the computing systems. In some examples, the data management engine 118 may extract relevant claims information from the claims records, transform the extracted data into a predetermined format, and store the transformed data as the claims data 140 to be used by model training engine 126 for training data models to determine cost-driving factors and predict future member claims based on the claims data 140.

In some implementations, the additional computing systems 107 can also include a subscription product management system as described in U.S. patent application Ser. No. 15/900,705, now U.S. Pat. No. 10,402,788, entitled “Dashboard Interface, Platform, and Environment for Intelligent Subscription Product Selection,” filed Feb. 20, 2018, and U.S. patent application Ser. No. 16/554,157, now U.S. Pat. No. 10,664,806, entitled “Dashboard Interface, Platform, and Environment for Intelligent Subscription Product Selection,” filed Aug. 28, 2019, the contents of which are incorporated herein by reference. In some examples, the subscription product management system may be a system that supports employers designing subscription product plans that appeal to both employer financial considerations and employee perceptions of subscription product plans. In some examples, the employee perception score is a predictive value determined based on customized, trained modeling data that indicates how favorably members in certain demographic categories regard subscription products based on demographic characteristics of the members and characteristics of the subscription product plans. In some implementations, the benefits administrations system 102 may request employee perception scores from the subscription product management system based on characteristics of subscription products offered by a given provider 106 and characteristics (e.g., questionnaire responses, demographic information, medical history) of members 108. In some implementations, the employee perception scores received from the subscription product management system can be used by the system 102 in generating subscription plan recommendations for member 108.

In some implementations, various modifications of the benefits administration system 102 may be contemplated, which may include modifications to structural and/or functional architecture components. For example, one or more of the engines 116, 118, 120, 122, 124, 126, 128, 130, 132, 134, 136, 138 may be separate from the system 102 yet communicate with the system, for example via an application programming interface (API). For example, client management engine 116 and/or GUI engine 132 may be external to the system 102.

In some implementations, the system 102 authenticates users connecting through the provider computing systems 106, member computing systems 108, and broker computing systems 104 through a client management engine 116. The client management engine 116, for example, may authenticate users and/or computing systems 104, 106, 108 based upon information stored within provider data 150 and member data 144. In some examples, user passwords, valid computing system addresses, dashboard GUI activity data, etc. may be maintained for individual providers 106 (via provider data 150) and/or members (via member data 144) connecting to the system 102.

When a provider 106 or member 108 accesses the system 102, a graphical user interface (GUI) engine 132 may present a member recommendation intake form to users (e.g., members 108) via a series of GUI screens that provide a series of user input fields, allowing a member to provide member demographic information, current plan selections, risk tolerance (e.g., willingness to incur OOP expenses), and responses to a member screening questionnaire. When a provider 106 accesses the system 102, the GUI engine 132 may present provider information input forms with a series of user input forms, allowing providers to provide information related to subscription product plan offerings and corresponding pricing information, current employee profile data, current employee selections, and financial goals related to how much the provider 106 is willing or able to spend on subscription products. In some implementations, GUI engine 132 can also present a series of member registration forms to new employees or members 108 who have not accessed the benefits administration system 102. In some examples, the member registration forms may allow new system users to provide basic demographic for the member and any family members covered under a provider-offered subscription product. In some examples, any member-related information provided at a member recommendation intake form or member registration form may be stored in data repository 112 as member data 144. In some examples, member data 144 can also include demographic data, employee information (e.g., employee identifier, job title, etc.), current benefits plan, and links to additional members sharing a plan with the member.

The GUI engine 132, in some implementations, may transmit information provided in any submitted GUI form to the respective processing engine for use in generating subscription product recommendations. In some examples, the submitted information may be delivered to the respective processing engine via the data management engine 118 and/or data repository 112. In some embodiments, responses to member questionnaires can be transmitted to questionnaire management engine 130 for processing. Further, member information extracted from client intake forms can be transferred to cluster management engine 120. In one example, provider plan information can be transmitted to product pre-scoring engine 124 and/or product recommendation engine 136.

In some implementations, the benefits administration system 102 includes a model training engine 126 that takes a set of claims data 140 for a population and trains machine learning data models to predict claims costs for a member 108 in the following year (year t+1) based on health characteristics of the member 108 in a current year (year t). In some implementations, machine learning data models can be separately trained for commercial populations (e.g., employee populations associated with one or more providers) or for a retired population (e.g., Medicare population).

In some embodiments, cluster management engine 120 generates one or more clusters of members (families or individuals) from the claims data 140 based one or more clinical categories (e.g., demographic information such as gender, age, salary, health risk level). The claims data 140, in some implementations, can also be clustered based on a member's claims in year t+1. For example, when two or more years of claims data 140 are available for a particular individual or family cluster, the cluster management engine 120 may generate an additional layer of clusters based on how much cost a given individual or family cluster incurred (both OOP by the member 108 or by the provider 106 of the subscription product plan) in year t+1. In some examples, the clusters and associated categorized claims data generated by the cluster management engine 120 for training machine learning data models can be stored in data repository 112 as training cluster data 156. Additionally, cluster definitions themselves (attributes that are associated with each cluster) can be stored as cluster data 148. In some implementations, the cluster management engine 120 can periodically update training cluster data 156. For example, the training cluster data 156 may be updated yearly as additional information regarding cost per medical insurance claim is available.

In some embodiments, the model training engine 126 can use the training cluster data 156 to train a first set of data models to determine predictive cost-driving factors 158 in a first year of claims data (year t) that can be used to explain claims-related costs in the following year (year t+1). In some implementations, these cost-driving factors 158 can be used to generate sets of questions that are presented to members 108. For example, starting a prescription medication (e.g., oral or injected insulin) in one year may indicate that a patient may have increased costs related to diabetes treatment in a following year. In another example, changes in a member's prescriptions or treatments under the subscription product plan may also indicate that the member 108 is interested in starting a family, which can be an indication of additional subscription product costs in a following year. Further, recurrent in-patient hospital stays for an individual or family can be an indicator that the member 108 is likely to have additional in-patient hospital stays in the future. In still another example, whether an individual is taking a particular drug and whether that drug is being taken for an on-label or off-label use can be used to predict future use and expense associated with the drug. For example, off-label use of certain drugs may result in higher OOP expenses for an individual than on-label use. Additionally, dosage for prescription drugs can also be predictive of future costs associated with subscription product plans because the dosage may indicate whether a condition treated by the drug is well-managed or difficult to manage. In some implementations, prescription drug information (dosage, type, on/off-label uses) can be translated into national drug codes and applied when the first data model in the cost-driving factor determination. In some implementations, in addition to determining cost-driving factors 158, the first data model can also determine a weighting factor for each cost-driving factor 158 that indicates a relative importance of the cost-driving factor to predicting subscription product expenditures for at least one following year. In some implementations the first trained data model can be stored in data repository as model data 142.

In some implementations, the model training engine 126 can train a second model to predict which cluster a member requesting a recommendation belongs to based on responses a member questionnaire that includes questions directed to one or more of the cost-driving factors identified by the first trained data model. In some examples, being trained with claims data 140 and training data 156 (including training cluster data and questionnaire response training data), the second data model (also stored as model data 142 in data repository 112) can output a member cluster assignment for a member 108 requesting a recommendation in response to receiving a set of questionnaire responses and demographic information (e.g., age/gender/family composition) from the respective member 108. In some aspects, the questionnaire response training data can include questionnaire responses for members that are associated with claims data 140. The questionnaire response training data, in some embodiments, can also or instead include respective items of claims data 140 that indicate what a response to a respective questionnaire question would be.

In some implementations, benefits administration system 102 can include a questionnaire management engine 130 that manages generation and processing of member questionnaires associated with subscription product recommendations. In some examples, when a member 108 initiates a query with the benefits administration engine 102, the member is presented a screening questionnaire that includes a number of questions associated with cost-driving factors identified by the first trained data model. In some embodiments, each identified cost-driving factor may be associated with one or more questions stored in data repository 112 as question data 154. The questionnaire questions can include both open-ended and close-ended questions. Examples of questionnaire questions can include “are you expecting a pregnancy in your family in the next year,” “how many in-patient visits did your family have in the past twelve months,” “what medications are you taking,” or “has anyone in your family received chemotherapy treatments in the last five years.”

In some implementations, the questionnaire can also include one or more questions directed to determining a member's risk tolerance as indicated by the member's willingness to absorb OOP expenses in premium amount and/or high deductible amount for the subscription product. In some implementations, question responses related to member risk tolerance may be saved as behavior data 146 in data repository 112 and can be used by behavioral calculation engine in determining an aspect of a subscription product recommendation process that determines subscription plan recommendations based on behavioral characteristics of each member 108. Upon receiving a set of cost-driving factors 158 from the first trained data model, in some implementations, the questionnaire management engine 130 identifies a set of questionnaire questions for presenting to the member. In some implementations, the questionnaire presented to each member 102 at enrollment may be five to ten questions in length.

In some examples, the question data 154 may be grouped by provider 106, and the providers 106 can manually adjust the set of questions presented to member 108 seeking subscription product recommendations from the benefits administration system 102. For example, a provider 106 may wish to suppress or remove one or more questionnaire questions based on sensitivity associated with the question. In one example, upon reviewing a question set generated by the questionnaire management engine 130 at a GUI screen, the provider 106 may select one or more of the questions for suppression. In response to receiving submission of one or more question suppression inputs, the questionnaire management engine 130 removes the questions from the questionnaire.

In some implementations, because the second data model is trained to identify a member cluster based on responses to all questions in a member questionnaire, suppression of one or more questions may cause additional data models to have to be trained to account for variations in question sets. In some embodiments, in order to account for question suppression without having to train additional models (which increases processing times and adds complexity to the subscription product recommendation process), the questionnaire management engine 130 can be configured to backfill missing question responses with estimated responses based on claims data attributes that share similarities with member attributes (e.g., demographic information, medical attributes, risk preferences, other questionnaire responses). This solution provides a technical solution to the technical problem of improving processing efficiency by minimizing the number of models that have to be trained by automatically inferring question responses based on pattern recognition of other similar attributes.

In some implementations, the benefits administration system 102 can include a product pre-scoring engine 124 that can be configured to ingest subscription product plan designs (e.g., medical, prescription, dental, vision) for each provider 106 and score each plan design for each defined cluster 148 and previously submitted member data 144 stored in data repository 112. In one example, the cluster management engine 120 assigns each member 108 associated with stored member data 144 to a given cluster of the cluster data 148. For example, the cluster assigned can be performed by applying member data to the second trained data model, which outputs the cluster assignment for each member 108. In some embodiments, for each subscription product plan level/cluster/member combination, the product pre-scoring engine 124 uses stored actuarial value (AV) data 152 to determine expected costs for each plan and member 108 based on the assigned cluster. In some implementations, the stored AV data 152 can be broken down by cluster category. In some examples, the expected costs can be separated out into plan-covered costs and member-covered OOP costs. In one example, each cluster and member 108 can be scored based on member-covered OOP costs (e.g., lower OOP costs would correspond to a higher or more favorable score for a product recommendation), which can be stored in data repository as cost data 141. In some implementations, the product pre-scoring engine 124 can use the AV data 152 to determine expected costs for each member 108 assigned to a cluster and calculate an average across all individual/families associated with that cluster for each plan (e.g., cluster/plan combination) to determine the expected OOP expenses for that cluster of members.

In some embodiments, the benefits administration system 102 can include a cost determination engine 128 that, responsive to receiving a query for a subscription product recommendation from a member 108, determines expected member costs for each offered subscription product plan. In some implementations, the cost determination engine 128 receives member responses to questionnaire questions, demographic information for the member 108, and available plan information for the member 108 as cost input information. In some examples, the cost input information may be accessed from data repository (e.g., plan information for each provider stored as provider data 150, member data 144 which can include medical history, past claims, current medications) and/or can be obtained via user inputs at one or more GUI screens (e.g., questionnaire responses). In some implementations, the cost input information is transformed into a member profile, which is applied to the second trained data model, which outputs a cluster assignment for the member 108 that best fits the member profile to cluster attributes. In some implementations, training of the second data model can occur in an offline environment such that cluster assignment of members 108 seeking recommendations can occur in real-time in response to receiving a recommendation request. Therefore, the model training and overall system design improves efficiency of processing member recommendation requests by preparing a custom, trained data model that accurately predict cluster assignment and also expected costs without having to perform computationally complex calculations upon receiving a recommendation request. In some examples, the cost determination engine 128 uses the cost data 141 (e.g., expected member OOP expenses) determined by product pre-scoring engine 124 combined with the respective subscription product plan's premium and/or member contribution to determine an expected total expenditure for each offered plan for the member 108. In some implementations, the calculated expected total expenditure is also stored as another type of cost data 141 in data repository 112.

In some embodiments, the benefits administration system 102 also includes a behavioral calculation engine 122 to determine an impact of one or more behavioral factors on member subscription product plan selection. While expected total expenditure per member per plan can be indicative of which product to recommend to a member 108 in some situations, in some implementations, other behavioral aspects can impact which subscription plans the member 108 may select. For example, members 108 may have variable risk tolerances based on how much OOP expense each member 108 is willing to take on. For example, a member 108 with a high-risk tolerance may prefer a low premium/high deductible and/or high catastrophic cap plan where the member 108 only pays a large OOP sum if the member 108 plus family makes frequent use of costly medical procedures and care. However, another member 108 may have a low-risk tolerance may instead prefer to take on less risk by paying a higher monthly premium amount with a lower deductible or catastrophic cap. In some examples, other behavior-related factors can include plan design preferences (e.g., HMO vs. PPO), referral procedures (e.g., ease with which members 108 can seek out specialized medical care), coverage of supplemental care (e.g., acupuncture or chiropractic care), desire to purchase additional coverage, desire of having doctors in-network, or willingness to pay for a higher Centers for Medicare and Medicaid Services (CMS) star rating.

In some implementations, the behavioral calculation engine 122 can construct a utility curve for each offered subscription product plan based on individual risk tolerances as indicated in questionnaire responses provided by members 108 and member preference information represented by employee perception scores obtained from a subscription product management system. As discussed above, in some examples, a subscription product management system that provides data to benefits administration system 102 may be a system that supports employers designing subscription product plans that appeal to both employer financial considerations and employee perceptions of subscription product plans. In some examples, the employee perception score is a predictive value determined based on customized, trained modeling data that indicates how favorably members in certain demographic categories regard subscription products based on demographic characteristics of the members and characteristics of the subscription product plans. With risk preference information obtained from questionnaire responses that are converted to employee perception scores by the subscription product management system, the behavioral calculation engine 122 can assign a utility values to each behavior-related factor, which can be stored in data repository as behavior data 146. In some examples, the questionnaire responses may include plan selections made by members of different demographic groups with different risk tolerances in response to being presented with multiple plans having varied attributes. For example, presented plans may be categorized based on premium, extreme loss, and/or doctor status. In some examples, the behavioral calculation engine 122 can use both a risk tolerance score and a behavior-based factor score to determine an overall behavior score per member and per plan, which can also be stored as behavior data 146. In some examples, employee perception scores for each plan design feature can be obtained from the subscription product management system, which can be used to construct the utility curve for each plan design.

In some examples, the utility curves are generated by running a part wise, constrained hierarchical Bayesian regression on the employee perception scores obtained from the subscription product management system. In some embodiments, utility curves can be assigned to a cluster/profile by matching up the questions/claims to what was asked on the survey and then selecting the utility function for that profile. The plan design, health status, expected out of pocket amounts, extreme out of pocket amounts, risk questions responses on the benefits administration surveys, and/or capacity to pay can be sent through the utility function to produce a utility score. The score, in one example, is normalized and presented as a comprehensive ranking of plans. In one example, the behavioral calculation engine 122 can assign a utility value to one or more non-quantitative preferences of plan designs (e.g., HMO vs. PPO, ability to purchase additional coverage, value of having in-network doctors). The determined utility values for behavior-based factors can be used to adjust product recommendation scores up and down based on a qualitative value of each behavior-related component to the member 108. By using trained modeling data related to member behavioral preferences to generate quantitative values for qualitative, behavior-based features of plan designs, the benefits administration system 102 provides a technical solution to a technical problem in that humans would be unable to quantitatively characterize such qualitative features without inserting human bias to skew the results in a particular direction. Additionally, the qualitative behavioral score adjustments allow the system to provide real-time recommendation results that are customized to the requesting member 108.

In some examples, the benefits administration system 102 can include a product recommendation engine 136 that uses the total estimated expenditure for each plan calculated by cost determination engine 128 and a behavior score for each plan determined by behavioral calculation engine 122 to generate subscription product recommendations for a member 108 in real-time in response to member queries. In some implementations, the behavior score can be used to adjust a calculated cost-based score up or down based on how appealing a plan is from a behavior-related standpoint. In one example, the cost-based score and behavior-based score can be averaged or combined to determine an overall recommendation score, also referred to as an economic equivalent score, for each plan and can also be stored as cost data 141 in data repository. In some examples, the economic equivalent score can reflect which design provides the best protection for the price and also incorporates behavior aspects that reflect an importance a given member gives to a given plan due to certain features associated with that plan.

In some examples, the product recommendation engine 136 can generate a ranked list of subscription product plans and transmit the ranked list to the GUI engine 132 for display to the requesting member 108. In one example, the product recommendation engine 136 can generate ranked lists for different categories of voluntary benefits that can be displayed in separate tabs. Additionally, rationale behind each recommendation can also be presented to the member 108 such as cost information (“this plan will likely result in the lowest OOP expenses for you”) and detected perceived benefit information (“we recommend this plan because it offers the highest number of in-network doctors”). In some implementations, the product recommendation engine 136 can develop an optimal benefits package for the member 108 across all types of offered subscription products. In one example, actual product selections made by the member 108 can be stored in data repository as selection data 155 and can be used by model training engine 126 as feedback to re-train and update the first and second data models to use learned knowledge to further improve the accuracy of recommendations made by the system 102.

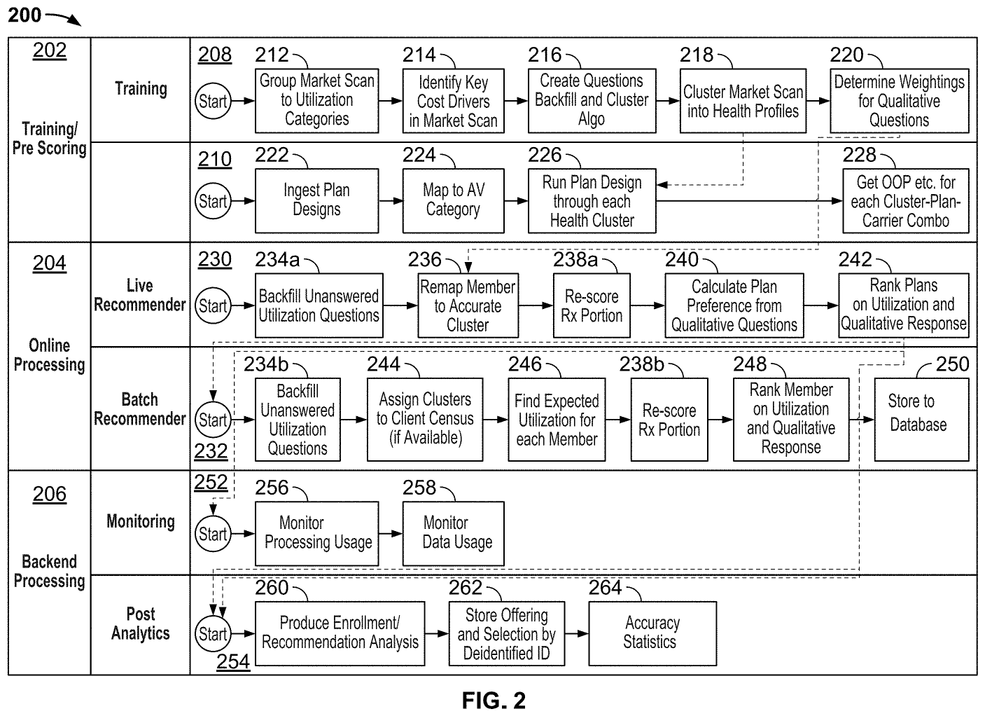

In some implementations, the benefits administration system 102 can also include a batch processing engine 134 that processes recommendations off-line for large sets of members 108 (e.g., Medicare or Medicaid members) to identify potential marketing opportunities and to better understand a member's needs during a first discussion during subscription product enrollment. In some examples, the batch processing engine 134 may periodically perform a subscription product recommendation process (e.g., see method 232 in FIG. 2) for groups of member data 144 to identify which subscription products may likely appeal to and/or provide optimal coverage for member sets sharing certain characteristics (e.g., being in a certain age or salary range, being eligible for Medicare, being eligible for Medicaid).

Turning to FIG. 2, a swim-lane diagram of interactions between components of a benefits administration system 200 (e.g., benefits administration system 102 in FIG. 1) is illustrated. In some implementations, the benefits administration system can include a training/pre-scoring platform 202, an online processing platform 204, and a backend processing platform 206. Each of the platforms 202, 204, 206, in some embodiments, can perform one or more of the functions performed by processing engines 116, 118, 120, 122, 124, 126, 128, 130, 132, 134, 136, 138 of the benefits administration system 102 described above. In some examples, the platforms 202, 204, 206 each control one or more processes that operate in parallel and exchange information with one or more sub-processes associated with each of the platforms 202, 204, 206. In some examples, a portion of the processes performed by the benefits administration system 200 are performed in advance of real-time processing (e.g., one or more times a year). Portions of the processes of the system 200 may be performed in real-time as a user engages with the system 200, and some reporting/analytics processes may be performed at periodic intervals after the system 200 has been in use for a period of time.

In some embodiments, training/pre-scoring platform 202 can be configured to perform a method 208 for training one or more machine learning data models to identify attributes of a member population that have a greatest impact on subscription product costs (both OOP to the member 108 and to the subscription product provider 106), determine questionnaire questions that best capture information with the identified cost-driving factors, and train machine learning data models to assign members to member clusters that are identified based on demographic and medical attributes of members in a set of claims data. In some examples, the training/pre-scoring platform 202 can also perform a method 210 for pre-scoring subscription product plans that includes mapping each subscription product design offered by a provider to an AV category and determine projected costs associated with each defined health cluster for each of the plan designs. In some examples, the training/pre-scoring platform 202 operates in an off-line environment to ingest claims data, train machine learning data models, determine health cluster groupings, and assign member populations to cluster groupings. In some implementations, performing the methods 208, 210 in an off-line environment further improves the efficiency of real-time recommendations generated by the system 200 since one or more operations associated with pre-scoring subscription products have already been performed.

In some implementations, method 208 for training machine learning data models and generating health clusters commences with grouping a set of subscription product claims data into utilization categories (212). In some examples, the utilization categories can include groups based on type of claim, type of insurance product plan (e.g., HMO, PPO, high deductible plan with health savings account (HSA), etc., Medicare, Medicaid). The utilization categories can also include groups by provider 106 or type of provider 106 (e.g., industry, number of employees, geographic region). In some examples, a machine learning data model can be trained with claims data associated with each of the utilization categories to identify one or more predominant cost driving factors in the set of ingested claims data (214). For example, the machine learning data model can predict claims costs for a member 108 in an upcoming year (year t+1) based on health characteristics and/or other demographic information of the member 108 in a current year (year t).

In some implementations, the training/pre-scoring platform 202 can generate member questionnaires with questions targeting each of the identified cost-driving factors and backfill any questions suppressed by a provider (216). Upon receiving a set of cost-driving factors from the first trained data model, in some implementations, the training/pre-scoring platform 202 identifies a set of questionnaire questions for presenting to the member. In some implementations, the questionnaire presented to each member 102 at enrollment may be five to ten questions in length. In some examples, providers 106 can manually adjust the set of questions presented to member 108 seeking subscription product recommendations from the benefits administration system 108. In one example, the system 200 may present multiple questions associated with a particular cost-driving factor to a provider 106, and the provider 106 selects one or more from the group of cost driving factors. In addition, a provider 106 may wish to suppress or remove one or more questionnaire questions based on sensitivity associated with the question or general preference to not ask a particular question. In one example, upon reviewing a question set generated by the platform 202, the provider 106 may select one or more of the questions for suppression.

In some implementations, because the set of second data models are trained to identify a member cluster based on responses to all questions in a member questionnaire, suppression of one or more questions may cause additional data models to have to be trained to account for variations in question sets. In some embodiments, in order to account for question suppression without having to train additional models (which increases processing times and adds complexity to the subscription product recommendation process), the system 200 can be configured to backfill missing question responses with estimated responses based on claims data attributes that share similarities with member attributes (e.g., demographic information, medical attributes, risk preferences, other questionnaire responses). In some examples, the training/pre-scoring platform 202 can be configured to generate question backfill estimation adjustments for the second set of models based on any questions a provider 106 chooses to remove from the questionnaire. In this way, the benefits administration system 102 provides a technical solution to the technical problem of having to deal with the processing complexities of having incomplete information that can vary from provider to provider and member to member. To solve the problem, the system estimates responses to any suppressed questions, which allows the same data models to be used for members 108 having varied sets of questionnaire responses.

In some implementations, the training/pre-scoring platform 202 can assign members from a set of claims data into one or more pre-defined health clusters that each share commonalities with respect to predicting subscription product costs. In some examples, the training/pre-scoring platform 202 can train a set of second machine learning data models to predict which cluster a member requesting a recommendation belongs to based on questionnaire responses (218). When the set of second machine learning data models are trained, in some embodiments, the data models can identify criteria for cluster groupings. In one example, cluster grouping criteria can correspond to criteria that break down cluster assignments into similarly sized cluster groupings. In other embodiments, cluster-defining criteria can be based on one or more predetermined categories (e.g., age, family size, gender). In some examples, the set of second machine learning data models can ingest claims data for a member population and assign each member to a cluster based on claims information that corresponds to a respective question in the member questionnaire.

In some examples, the training/pre-scoring platform 202 can also determine relative weighting factors for each of the questionnaire questions that reflect a relative impact of each question on driving costs associated with each subscription product plan (220). For example, having an in-patient hospital stay, being diagnosed with cancer within the past year, being on a high dosage of insulin may have a greater impact on subscription product costs than having had an appendectomy or minor surgical procedure within a predetermined period of time.

Although illustrated in a particular series of events, in other implementations, the steps of the machine learning data model training process 208 may be performed in a different order. Additionally, in other embodiments, the training process 208 may include more or fewer steps while remaining within the scope and spirit of the machine learning data model training process 208. For example, the method 208 may include separate individual steps for training of the sets of first data models (for identifying cost-driving factors) and second data models (for assigning member population to clusters) and/or may not include the step for determining weightings for qualitative questions (220) in embodiments where each question has the same weighting.

In some implementations, method 210 for pre-scoring subscription product plans commences with ingesting subscription product plan designs offered by a provider 106 (222). In some examples, each subscription product plan offered by a product provider may have one or more coverage and/or pricing tiers, voluntary and/or supplemental benefits, or savings account structures that impact product coverage costs. In one example, each plan design corresponds to a selection and/or combination of coverage associated with a subscription product plan offered by a given provider 106. In some embodiments, the training/pre-scoring platform 202 maps each offered plan design to an AV category (224), and each mapped plan design can be applied to each cluster (as determined at 218) to determine costs associated with each plan design/cluster combination (226). In some examples, the mapped plans/AV categories can be used to determine expected costs for each plan design and member 108 based on the assigned cluster (228). In some implementations, stored AV data can be broken down by cluster category. In some examples, the expected costs can be separated out into plan-covered costs and member-covered OOP costs. In one example, each cluster and member 108 can be scored based on member-covered OOP costs (e.g., lower OOP costs would correspond to a higher or more favorable score for a product recommendation). In some implementations, the AV data can be used to determine expected costs for each member 108 assigned to a cluster and calculate an average across all individual/families associated with that cluster for each plan design (e.g., cluster/plan design/carrier combination) to determine the expected OOP expenses for that cluster of members.

Although illustrated in a particular series of events, in other implementations, the steps of the subscription product pre-scoring process 210 may be performed in a different order. Additionally, in other embodiments, the pre-scoring process 210 may include more or fewer steps while remaining within the scope and spirit of the subscription product pre-scoring process 210. For example, the method 210 may delineate additional steps for determining multiple variations subscription product plan design scenarios that include multiple types of cross-product coverages such as supplemental coverages.

In some examples, online processing platform 204 can be configured to perform a method 230 that generates live subscription product plan recommendations in response to member enrollment queries. In some implementations, the live recommendation process 230 can include backfilling any unanswered questionnaire questions, assigning the requesting member to a health cluster, and generating ranked subscription product recommendations based on projected costs for the assigned cluster. In some examples, the live recommendation process 230 can generate subscription product recommendations for members in real-time in response to receiving a recommendation request. In addition to providing ranked results, in one example, the online processing platform 204 can provide rationale for the recommendation decisions that provide insight into why a subscription product plan design has been recommended for a particular member 108. In this way, the benefits administration system 102 provides a technical solution to a technical problem in that it can generate intuitive recommendation results for members 108 from trained models by making inferences from machine learning model outputs and calculation results that humans would be unable to perform in real-time or even manually in non-time situations.

In some embodiments, the online processing platform 204 can also be configured to perform a method 232 that executes batch subscription product recommendations for certain member population categories (e.g., Medicare, Medicaid). In some examples, the recommendations generated by the batch recommendation process 232 can be used to highlight targeted areas and demographics for marketing efforts. Additionally, in some examples, portion of the batch recommendation process 232 may include the same or similar steps as the subscription product recommendation process 230 (e.g., backfilling questionnaire responses (234a,b) and re-scoring prescription (Rx) portions (238a,b)).

In some implementations, the live recommendation process 230 begins with, in response to receiving a member recommendation request that includes responses to a set of questions in a questionnaire, backfilling any unanswered questions associated with cost-driving factors that have been removed from the questionnaire (234a). In some implementations, the online processing platform 204 can perform backfill estimation adjustments when one or more questionnaire questions have been suppressed by a provider 106. In some embodiments, in order to account for question suppression without having to train additional models (which increases processing times and adds complexity to the subscription product recommendation process), the system 200 can be configured to backfill missing question responses with estimated responses based on claims data attributes that share similarities with member attributes (e.g., demographic information, medical attributes, risk preferences, other questionnaire responses). In some examples, the training/pre-scoring platform 202 can be configured to generate question backfill estimation adjustments for the second set of models for any questions a provider 106 chooses to remove from the questionnaire. In some examples, the online processing platform 204 may infer questionnaire responses from available member data and claims data and/or responses from other members sharing similar attributes.

In some examples, based on the responses to the questionnaire and backfill adjustments that are applied to the set of second machine learning data models that output a cluster grouping assignment for the member 108, which can be re-mapped to an updated cluster based on the response weightings determined by training/pre-scoring platform 202 at step 220 (236). In some examples, the cluster assignment determined by the second set of trained data models can be used to determine subscription product costs for each plan design offered by the respective provider 106 based on the mapped AV category/plan design/carrier combination for the requesting member 108. In some implementations, member OOP expenses and/or provider expenses may correlate to a raw cost-based score for each plan design available to the member 108. In some embodiments, a prescription (Rx) portion of a plan design score (e.g., an amount that prescription medication costs factor into subscription product costs) can be re-adjusted to reflect projected prescription medical costs in the next year (238a). In some implementations, the re-adjustment and re-scoring for prescriptions works the same way as the AV category/cluster mapping but based on accounting for an impact that being subscribed certain medications has on subscription product costs. For a retiree/Medicare model, the system may receive exact drug costs under the plan design from the CMS formulary. In some examples, prescription drugs can be used to help identify chronic conditions. In addition, the calculated prescription drug cost can be translated into a prescription cost.

In some embodiments, the online processing platform 204 can determine subscription product recommendation scores for the requesting member 108 by incorporating qualitative behavioral aspects into subscription product plan scores (240). While expected total expenditure per member per plan can be indicative of which product to recommend to a member 108 in some situations, in some implementations, other behavioral aspects can impact which subscription plans the member 108 may select. For example, behavioral preferences of the member 108 can be reflected in questionnaire responses and can indicate different types of preferences such as preferences for coverage versus risk tolerance, willingness to pay OOP expenses, availability of supplemental coverage, plan preference type (HMO versus PPO), preferences for in-network practitioners, and value of having a particular CMS star rating.

In some implementations, the online processing platform 204 can construct a utility curve for each offered subscription product plan based on individual risk tolerances as indicated in questionnaire responses provided by members 108 and member preference information represented by employee perception scores obtained from a subscription product management system (an external system 107 in FIG. 1). In some examples, the employee score is a predictive value determined based on customized, trained modeling data that indicates how favorably members in certain demographic categories regard subscription products based on demographic characteristics of the members and characteristics of the subscription product plans. With risk preference information obtained from questionnaire responses that are converted to employee perception scores by the subscription product management system, the online processing platform 204 can assign a utility values to each behavior-related factor, which can be stored in data repository as behavior data 146. In some examples, using the utility values (e.g., employee perception scores) for the behavior-related factors, the online processing platform 204 can convert the cost-based plan design scores into economic equivalent values that are used to make subscription product recommendations to the member 108. In some examples, the utility values for each qualitative, behavior-based factor can be used to adjust a cost-based score up or down, resulting in the economic equivalent plan value that incorporates both quantitative cost-based) and qualitative (behavior-based) preferences of the member 108.

In some examples, using the scores for each subscription product plan design that have been adjusted to take into account behavioral factors, ranked plan recommendations are generated and presented to the member 108 via one or more GUI screens (242). In some examples, a ranked list of subscription product plans can be generated and displayed at a GUI screen for viewing by the requesting member 108. In one example, the online processing platform 204 can generate ranked lists for different categories of voluntary benefits that can be displayed in separate tabs. Additionally, rationale behind each recommendation can also be presented to the member 108 such as cost information (“this plan will likely result in the lowest OOP expenses for you”) and detected perceived benefit information (“we recommend this plan because it offers the highest number of in-network doctors”). In some implementations, the online processing platform 204 can identify an optimal benefits package for the member 108 across all types of offered subscription products.

Although illustrated in a particular series of events, in other implementations, the steps of the subscription product recommendation process 230 may be performed in a different order. Additionally, in other embodiments, the subscription product recommendation process 230 may include more or fewer steps while remaining within the scope and spirit of the subscription product recommendation process 230. For example, the method 230 may not perform re-scoring for a prescription medication portion of a utilization score (238a).

In some embodiments, the batch recommendation process 232 begins with backfilling unanswered questionnaire questions associated with cost-driving factors (234b). In some examples, because the batch recommendation process 232 may not be associated with a particular recommendation request, questionnaire responses may not be available for a portion of the questions. When some or all of the questionnaire responses are unavailable, the online processing platform 204 can perform backfill estimation adjustments by inferring questionnaire responses from available member data and claims data.

In some implementations, the online processing platform 204 can assign each member of a member population to a particular cluster by running the member population through a set second machine learning data models trained to make cluster assignments based on backfilled or actual questionnaire responses (244). Additionally, in some examples, expected subscription plan costs (utilization costs that include both member OOP expenses and provider costs) can be determined for each member in the member population based on cluster assignment/AV category/carrier combination for the respective plan design (246). In some embodiments, a prescription (Rx) portion of a plan design score (e.g., an amount that prescription medication costs factor into subscription product costs) can be re-adjusted to reflect projected prescription medical costs in the next year (238b).

In some implementations, the online processing platform 204 can generate member rankings for each subscription product plan design based on cost-based scores that have been adjusted for behavioral factors (248). In some examples, the member rankings are generated similarly to the plan design rankings (242) of the subscription product recommendation process 230. However, instead of ranking plans for a particular member, members are ranked for each subscription product plan so that providers 106, brokers 104, or other system users making determinations about marketing efforts can identify which members are best suited to particular plan designs. For example, the cost-based scores can be adjusted to an economic equivalent score based on utilization scores associated with behavioral factors obtained from an external subscription product management system (e.g., employee perception scores that reflect a preference for one or more qualitative aspects of a plan design). In some implementations, the member rankings for each plan design can be stored in a data repository (e.g., data repository 112 in FIG. 1) as additional member data that can be accessed by system users (250).

Although illustrated in a particular series of events, in other implementations, the steps of the batch recommendation process 232 may be performed in a different order. Additionally, in other embodiments, the batch recommendation process 232 may include more or fewer steps while remaining within the scope and spirit of the batch recommendation process 232. For example, the method 232 may not perform re-scoring for a prescription medication portion of a utilization score (238b).

In some implementations, the system 200 can also include a backend processing platform 206 that performs one or more backend processes associated with monitoring usage, managing operations of processing resources of the system 200, and analyzing post-enrollment recommendations to evaluate accuracy and improve system performance. For example, a method 252 for monitoring processing resource usage by the system can be configured to monitor processing resource usage statistics (256) and performing data usage monitoring to ensure that processing resources are available as needed by the platforms 202, 204, 206.

In addition, the backend processing platform 206 can perform method 254 for assessing accuracy of rankings and recommendations made by the system 200. In some examples, the method 254 begins with generating an enrollment/recommendation analysis that can compare subscription product recommendations to actual enrollment selections made by members 108 (260). In some implementations, to maintain member privacy, recommendation/enrollment selection combinations may be stored with a deidentified identification code in a data repository (262). In some examples, the deidentified recommendation/enrollment selection data can be used to generate accuracy statistics for the system 200 (264). In some examples, the accuracy statistics can be used to target refining and retraining of data models to adjust cost-driving factors, cluster assignments, or other training variables that impact the results output by the system 200.

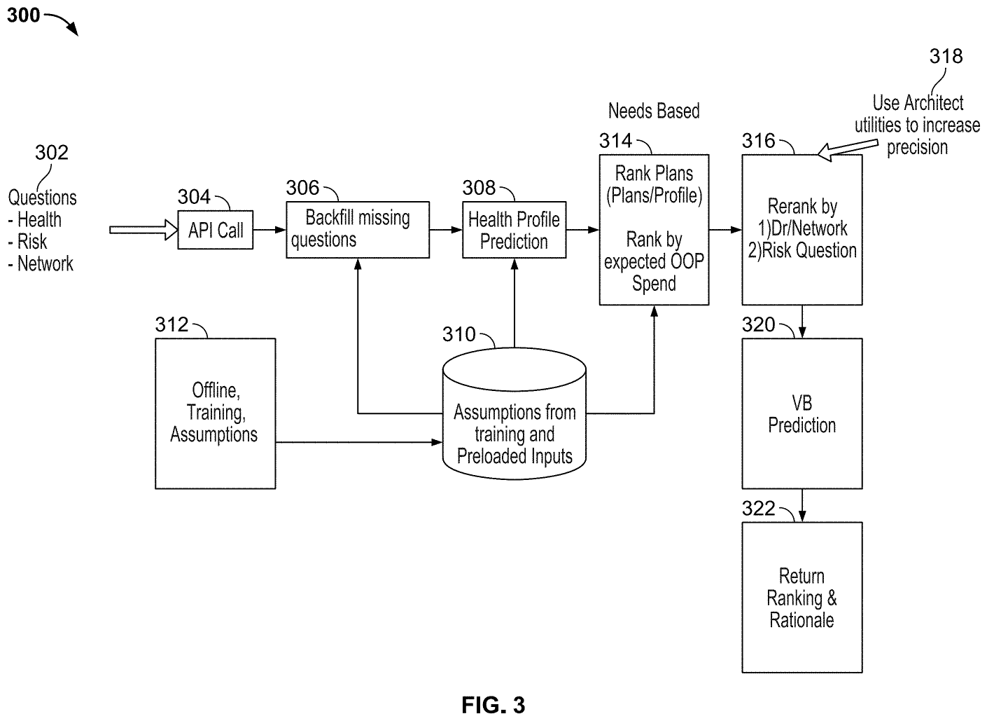

Turning to FIG. 3, a diagram of a workflow 300 for a real-time recommendation process performed by an online algorithm of a benefits administration system (e.g., benefits administration system 102 in FIG. 1 and system 200 in FIG. 2) is illustrated. In some implementations, the workflow 300 begins with a member 108 interacting with an application program interface (API) (304) to provide member enrollment inputs that include questionnaire responses to questions targeting cost-driving factors (302) as well as other information related to member demographics and health. As discussed above, a set of machine learning data models can be trained to identify cost-driving factors by ingesting claims data for a member population that includes member data over a period of multiple years so that claims data in a first year (year t) can be used to determine cost-driving factors for subscription product claims costs in a second year (year t+1) or other future year.

In some examples, in response to receiving an enrollment recommendation request via API call (304), the workflow 300 backfills any missing responses (306) with response estimations from stored training data and assumptions (310). In some implementations, as discussed above, the workflow 300 incorporates offline system training and assumption results (312) from training one or more sets of machine learning data models to identify cost-driving factors, generating questionnaire questions from the cost-driving factors, training one or more sets of machine learning data models to assign members to one or more health clusters based on questionnaire results, and generating backfill estimation adjustments for any possible combinations of suppressed questions. In some examples, applying backfill adjustments for missing questionnaire responses allows the workflow 300 to use the same sets of machine learning data models to determine cluster assignments (also referred to as health profile predictions) (308) without having to train multiple data models to account for multiple question combinations. In some implementations, the workflow applies the member questionnaire responses and any backfill adjustments to a set of trained machine learning data models, resulting in a health cluster assignment (308). In one example, the cluster assignment is based on shared cost-driving attributes between the member requesting a recommendation and members associated with a set of claims data used to train the machine learning data model.

In some examples, stored training and assumption data (312) can also include expected costs for each plan design/health cluster combination for all plan designs offered by a provider. This expected cost data, in some implementations, can be used by the workflow 300 to rank all plan designs offered by the respective provider by expected OOP expense for the requesting member (314). In some implementations, the workflow 300 can re-rank offered plan designs by taking into account qualitative behavioral factors of the member as indicated in questionnaire responses and other preferences (316). While expected total expenditure by the member per plan can be indicative of which product to recommend, in some implementations, other behavioral aspects can impact which subscription plans the member may select. For example, behavioral preferences of the member 108 can be reflected in questionnaire responses and can indicate different types of preferences such as preferences for coverage versus risk tolerance, willingness to pay OOP expenses, availability of supplemental coverage, plan preference type (HMO versus PPO), preferences for in-network practitioners, and value of having a particular CMS star rating.

In some implementations, a utility curve can be constructed for each offered subscription product plan based on individual risk tolerances as indicated in questionnaire responses provided by the member and member preference information represented by employee perception scores obtained from a subscription product management system (referred to as Architect in FIG. 3 and an external system 107 in FIG. 1) (318). In some examples, the employee perception score is a predictive value determined based on customized, trained modeling data that indicates how favorably members in certain demographic categories regard subscription products based on demographic characteristics of the members and characteristics of the subscription product plans. With risk preference information obtained from questionnaire responses that are converted to employee perception scores by the subscription product management system, utility values can be assigned to each behavior-related factor, which can be used to re-rank the plan designs to predict which plan designs best fit coverage needs and preferences of the member (voluntary benefits (VB) prediction 320).

In some examples, using the scores for each subscription product plan design that have been adjusted to take into account behavioral factors, ranked plan recommendations are generated and presented to the member via one or more GUI screens (322). Additionally, rationale behind each recommendation can also be presented to the member such as cost information (“this plan will likely result in the lowest OOP expenses for you”) and detected perceived benefit information (“we recommend this plan because it offers the highest number of in-network doctors”). In some implementations, an optimal benefits package can be identified for the member across all types of offered subscription products.

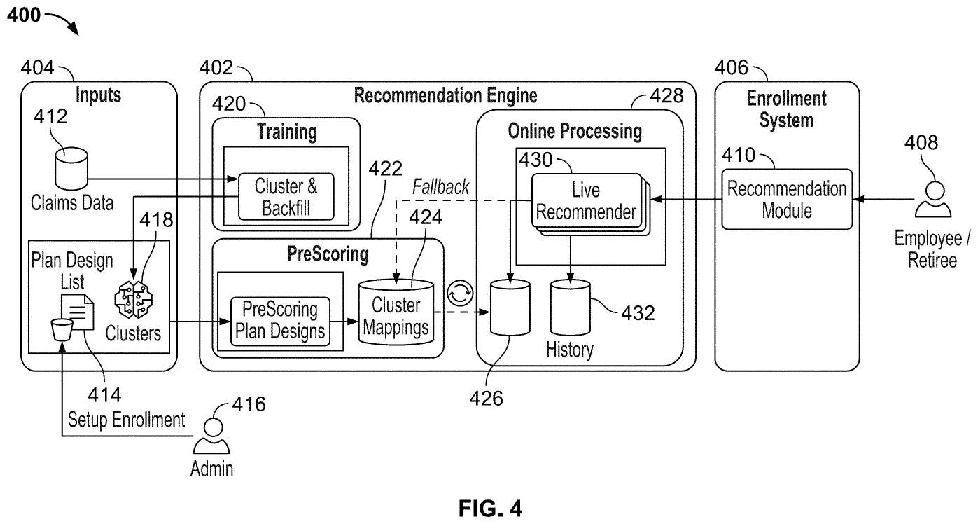

Turning to FIG. 4, a data architecture for a benefits administration system 400 (e.g., benefits administration system 102 in FIG. 1) is illustrated. In some examples, the benefits administration system 400 can include an enrollment system 406 that interfaces directly with members 408 to obtain member information and provide recommendations via a recommendation module 410. In some implementations, recommendation engine 402 interfaces with data inputs 404 stored in one or more data repositories. In some examples, the data inputs 404 include claims data 412 for one or more member populations used by training sub-engine 420 to determine cost-driving factors and define attributes for health clusters. In addition, the data inputs 404 can also include plan design attributes 414 provided to the system 400 by provider administrators 416. In some implementations, upon determining cluster defining attributes and assigning each member of the member population from the claims data 412 to a cluster, the training sub-engine 420 stores cluster data 418 for use by one or more sub-engines of the recommendation engine 402.

In some embodiments, the recommendation engine 402 can include a pre-scoring sub-engine 422 that, for each subscription product plan level/cluster/member combination from the claims data 412, determine expected costs by the member and cluster for each plan design offered by the provider 416 using stored AV data. In some examples, the expected costs can be separated out into plan-covered costs and member-covered OOP costs. In one example, each cluster and member 108 can be scored based on member-covered OOP costs (e.g., lower OOP costs would correspond to a higher or more favorable score for a product recommendation), which can be stored as cluster mapping data 424. In some implementations, the pre-scoring sub-engine 422 can use the AV data to determine expected costs for each member assigned to a cluster and calculate an average across all individual/families associated with that cluster for each plan (e.g., cluster/plan combination) to determine the expected OOP expenses for that cluster of members. In some aspects, the cluster mappings 424 can be stored in memory 426 of online processing sub-engine 428. In some examples, pre-determining the cluster mappings 424 allows online processing engine 428 in real-time in response to receiving recommendation requests.

Recommendation engine 402, in some examples, can include an online processing sub-engine 428 that generates real-time subscription product recommendations in response to requests received via enrollment system 406 as discussed above for FIGS. 1-3. In some implementations, one or more software processes of the online recommendation sub-engine 428 are executed by processing resources of a cloud computing environment 430 that can be scaled up or down as processing load increases or decreases. In one example, the cloud computing environment 430 is provided by a third-party platform such as Amazon Web Services Lambda platform. In some embodiments, the online processing sub-engine 428 can assign the requesting member 408 to one of the stored cluster mappings to determine expected costs associated with each offered subscription product plan design. In addition, cost-based scores for each of the offered plan designs can be adjusted up or down based on utility scores for one or more qualitative behavior-based attributes that may impact enrollment decisions of a member 408. Subscription product plan recommendations and rationale, in some examples, can be provided to the member 408 via recommendation module 410, and recommendation results can also be stored in data repository 432 of online processing sub-engine 428. In one example, historical recommendation data 432 can be used by online processing sub-engine in referencing past recommendations made to the member 408, which can inform future recommendations.

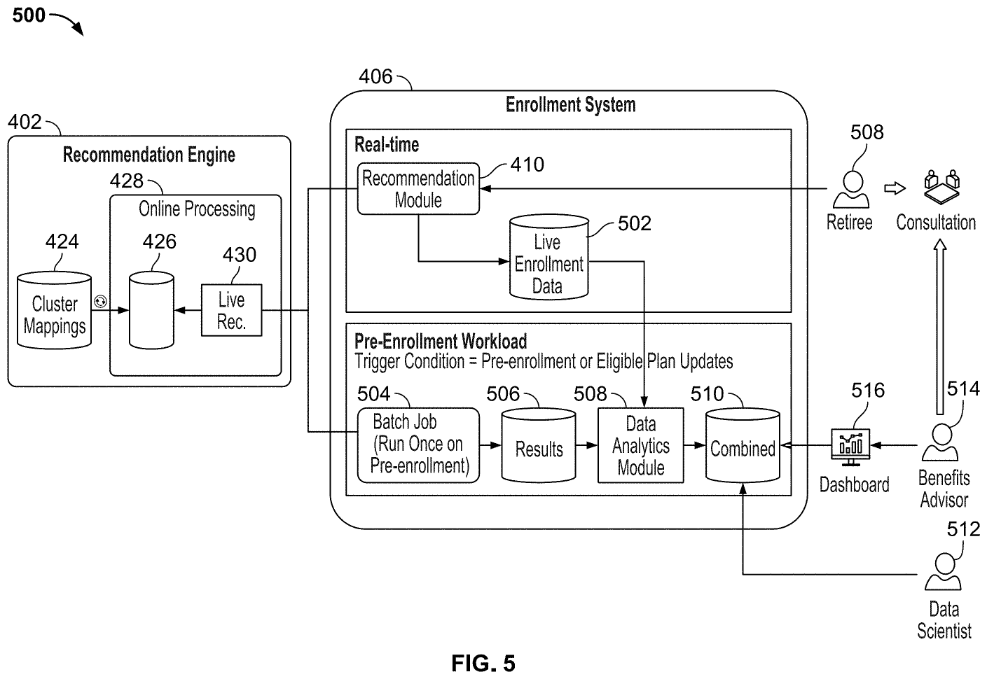

Turning to FIG. 5, a data architecture for a benefits administration system 500 (e.g., benefits administration system 102 in FIG. 1) for performing batch recommendations is illustrated. In some examples, recommendation engine 402, cluster mappings 424, online processing sub-engine 428, memory 426, cloud computing environment 430, enrollment system 406, and recommendation module 410 correspond to the same respective components described above for FIG. 4. In some implementations, the enrollment system 406 allows members 508 (e.g., members of a retiree population) to real-time subscription product recommendations from the recommendation engine 402 via recommendation module 410. In some examples, real-time request-based recommendations can be stored as live enrollment data 502 at the enrollment system 406.

In addition to real-time recommendations managed by recommendation module 410, in some implementations, the enrollment system 406 can also include a batch job sub-engine 504 that performs the same processes as batch processing engine 134 in FIG. 1 and/or batch recommendation process 232 performed by online processing platform 204 in FIG. 2. For example, batch job sub-engine 504 processes recommendations off-line for large sets of members 108 (e.g., Medicare or Medicaid members) to identify potential marketing opportunities and to better understand a member's needs during a first discussion during subscription product enrollment. In some examples, the batch job sub-engine 504 may periodically perform a subscription product recommendation process (e.g., see method 232 in FIG. 2) for groups of member data to identify which subscription products may likely appeal to and/or provide optimal coverage for member sets sharing certain characteristics (e.g., being in a certain age or salary range, being eligible for Medicare, being eligible for Medicaid).

In some examples, results 506 generated by batch job sub-engine 504 can include sets of members that are ranked in terms of suitability for each available subscription product plan design. In one example, stored results 506 generated by the batch job sub-engine 504 can be applied to a data analytics module 508 such as Alteryx Analytics Hub that can analyze the results and generate combined data analytics 510 for viewing by data scientists 512 and/or benefits advisors 514 via a benefits administration dashboard 516. For example, the data analytics 510 can include visual representations of member attributes that are best suited to each of the offered subscription product plan designs and/or projected costs associated with each recommendation. In some examples, based on the data analytics provided at the benefits administration dashboard 516, benefits advisors 514 can consult with members 508 regarding the subscription plan designs that best suit needs and preferences of each of the members 508.

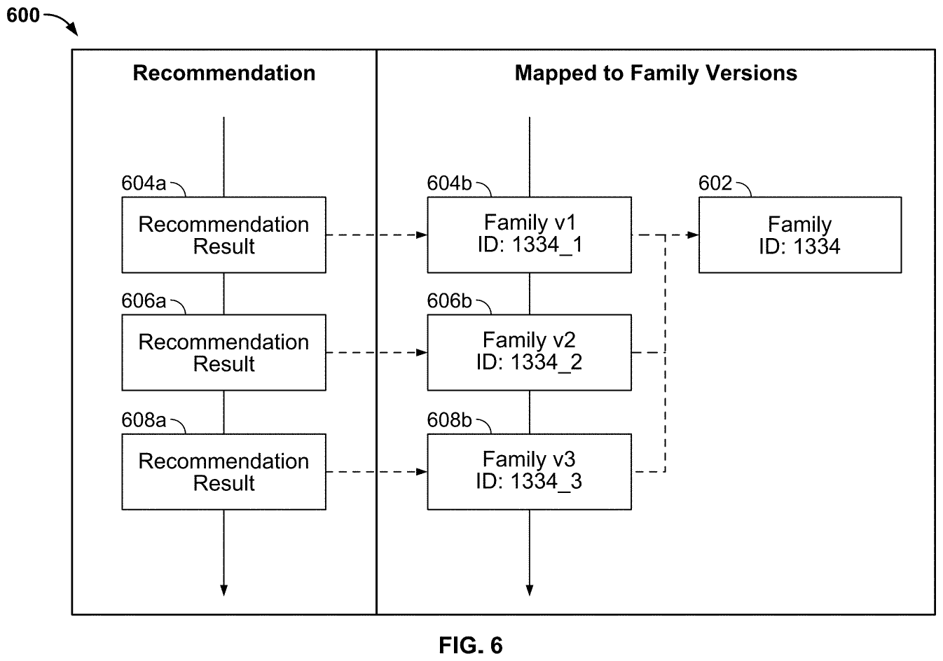

Turning to FIG. 6, a diagram of a recommendation result data structure 600 for a member family is illustrated. In one example, the recommendation result data structure 600 corresponds to a data structure of recommendation data 160 in data repository 112 (FIG. 1) and can represent a snapshot of a family entity in time. In some implementations, the results 600 represent recommendation results for a single subscriber family (member) in a benefits administration system. In some examples, when a member (e.g., member family 602) requests enrollment recommendations from the benefits administration system, sets of ranked recommendation results 604a, 606a, 608a are generated as discussed above. In one example, each recommendation result 604a, 606a, 608a corresponds to a separate enrollment/recommendation session. In some examples, each recommendation result 604a, 606a, 608a is saved as a separate respective family version 604b, 606b, 608b that is linked to the respective member family 602. This data structure 600 of having independent family versions 604b, 606b, 608b for recommendation result sets 604a, 606a, 608a allows multiple recommendations to be traced back to a single family 602. In some embodiments, the data structure 600 allows the benefits administration system to determine recommendation accuracy, track enrollment selections for each member over time, and retrain machine learning data models to improve recommendation accuracy.

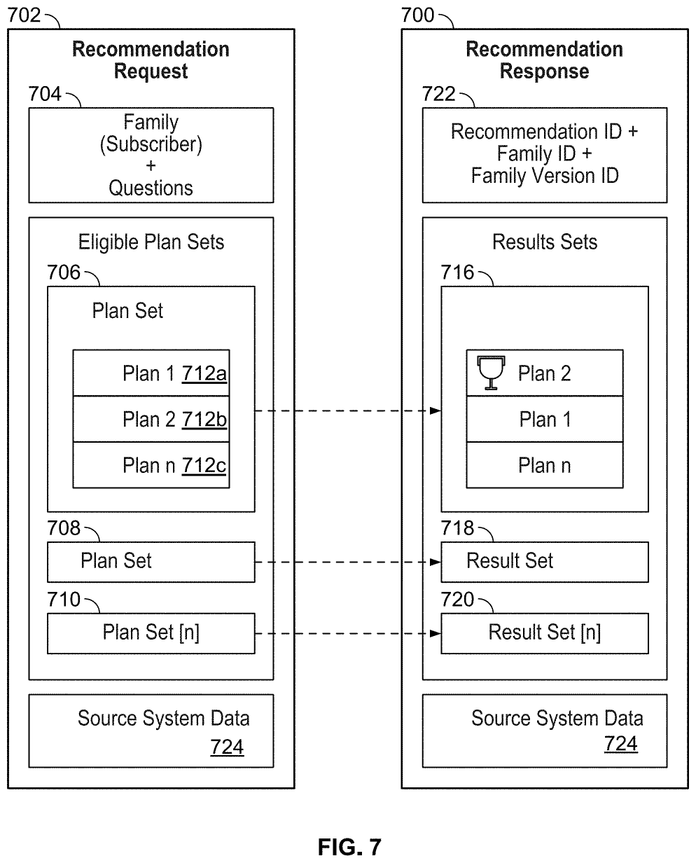

FIG. 7 illustrates a diagram of recommendation results 700 provided by a benefits administration system (e.g., system 102 in FIG. 1, system 200 in FIG. 2, or system 300 in FIG. 3) in response to a respective recommendation request 702. In some implementations, a given recommendation request processed by a benefits administration system includes member inputs 704 such as subscriber family (member) demographic and medical information as well as responses to questions targeting one or more cost-driving factors. In some implementations, the benefits administration system generates subscription product recommendations from one or more eligible plan types 706, 708, 710 that each can be broken down into one or more plan designs 712a,b,c. In one example, a first plan type 706 can be a Medigap plan type and a second plan type 708 can be a Medicare Advantage Prescription Drug (MAPD) plan type. Other plan types 710 can include HMO, PPO, or other plan types. In some examples, the recommendation request 702 and results 700 can also include additional source system data 724 for presenting with the other inputs and/or results.

In some embodiments, the recommendation results 700 are a assigned a recommendation identification (ID), family ID, and version ID 722 as described above (FIG. 6). In some implementations, the system generates results sets for each eligible plan design type 706, 708, 710 included in the recommendation request. In some examples, results sets 716, 718, 720 include ranked results for the respective plan design type 706, 708, 710 such that each set of eligible plan design types 706, 708, 710 and corresponding results 716, 718, 720 are independent of results for other plan design types. In other examples, the benefits administration system can be configured to rank plans against other eligible plan types. Additionally, as shown in FIG. 7, the benefits administration system can provide multiple sets of recommendation results 716, 718, 720 in real-time in response to a single request.

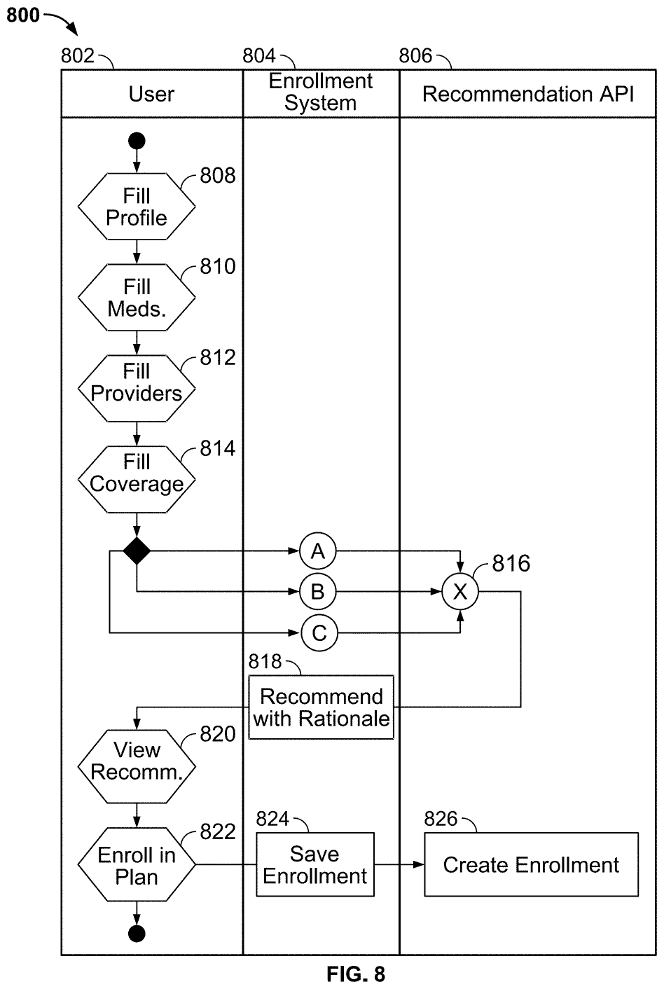

Turning to FIG. 8, a flow chart of a subscription product recommendation process 800 is illustrated. In some implementations, a user 802 (e.g., a member 108) can submit a recommendation request via enrollment system 804. The recommendation request, in some implementations, can include one or more questions and/or input fields for providing user profile information 808, prescription medication information 810 (e.g., medication type, dosage, on- or off-label usage), provider preferences 812 (in- or out-of-network provider preferences), and/or coverage preferences 814 (e.g., risk tolerance, OOP cost preferences, plan type preferences).

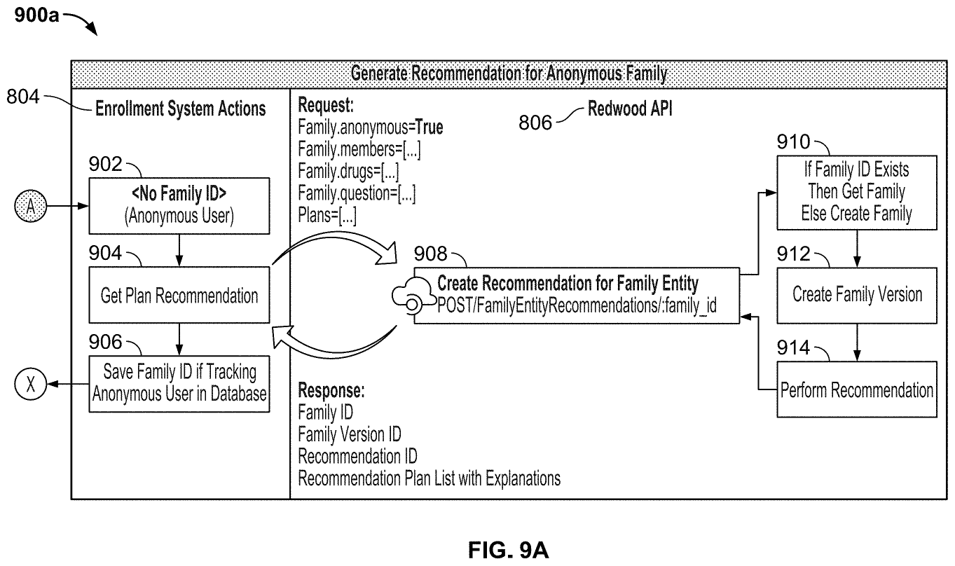

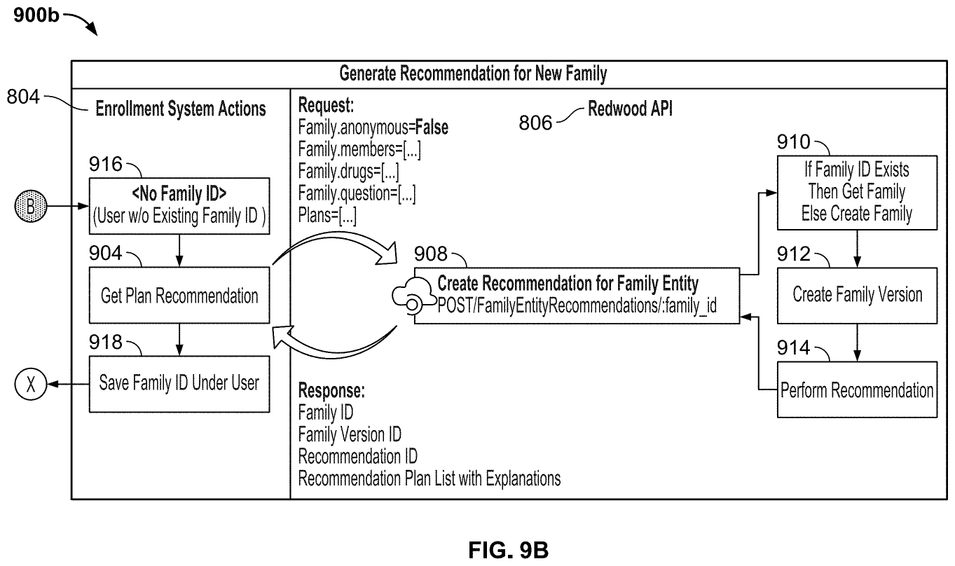

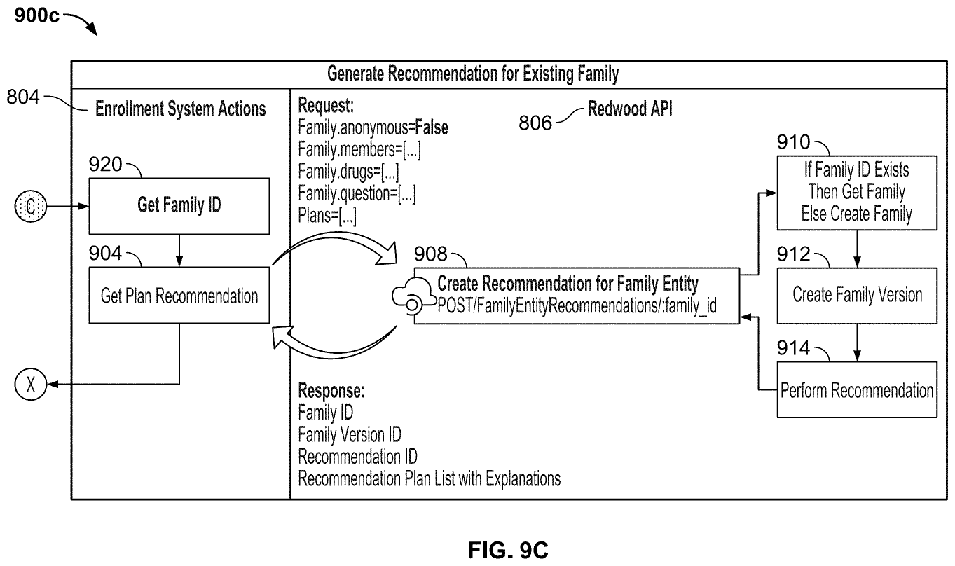

In some embodiments, in response to receiving a submitted recommendation request with responses 808, 810, 812, 814, enrollment system 804 may perform a member enrollment process A, B, or C based on a type of member requesting the recommendation (e.g., anonymous member (A), new member (B), previously enrolled member (C), and recommendation API 806 executes a recommendation generation process 816 such as the recommendation processes described above. For example, FIGS. 9A-9C illustrate flow charts of member enrollment and recommendation processes based on each of the member types A, B, and C. In some implementations, the flow charts in FIGS. 9A-9C provide a detailed view of the call/response for a portion of the member enrollment and recommendation processes. In one example, FIG. 9A illustrates a flow chart of method 900a for enrolling and generating recommendations for an anonymous member (branch A in FIG. 8). In some examples, such as when a member does not wish to have personal information saved at the benefits administration system, when the system is being used to generate recommendations for anonymous claims data, or other situations where member personal information is anonymous. For example, the recommendation request submitted at enrollment system 804 may indicate that the user is an anonymous user (902). In some examples, the enrollment system 804 may submit the recommendation request to recommendation API 806 (904), which in some embodiments can include submitting a processing job to a cloud computing environment or other computing system to generate a subscription product recommendation (908). In some implementations, creating subscription product recommendations can include creating a member ID for the anonymous user if one has not yet been created (910), creating a version for the recommendation request (see description in FIG. 6 above) (912), and performing a subscription product recommendation for the user as described above in various implementations (914). In some examples, when the recommendation API 806 returns the recommendation results to the enrollment system 804, the recommendation results and corresponding member ID can be linked and stored in a data repository for tracking and analysis (906).

In some implementations, FIG. 9B illustrates a flow chart of method 900b for enrolling and generating recommendations for a new member who has not yet interacted with the benefits administration system (branch B in FIG. 8). For example, the recommendation request submitted at enrollment system 804 may indicate that the user is a new user (916). In some examples, the enrollment system 804 may submit the recommendation request to recommendation API 806 (904), which in some embodiments can include submitting a processing job to a cloud computing environment or other computing system to generate a subscription product recommendation (908). In some implementations, creating subscription product recommendations can include creating a member ID for the new user (910), creating a version for the recommendation request (see description in FIG. 6 above) (912), and performing a subscription product recommendation for the user as described above in various implementations (914). In some examples, when the recommendation API 806 returns the recommendation results to the enrollment system 804, the recommendation results and corresponding member ID for the user can be linked and stored in a data repository for tracking and analysis (918).

In some implementations, FIG. 9C illustrates a flow chart of method 900c for enrolling and generating recommendations for member who has previously interacted with the benefits administration system and already has a member (family) ID established (branch C in FIG. 8). For example, the recommendation request submitted at enrollment system 804 may indicate that the user has previously used the system 804 for recommendations and/or enrollment (920). In some examples, the enrollment system 804 may submit the recommendation request to recommendation API 806 (904), which in some embodiments can include submitting a processing job to a cloud computing environment or other computing system to generate a subscription product recommendation (908). In some implementations, creating subscription product recommendations can include accessing a member ID for the user if one has previously been created (910), creating a version for the recommendation request (see description in FIG. 6 above) (912), and performing a subscription product recommendation for the user as described above in various implementations (914).

Returning to FIG. 8, in some implementations, enrollment system 804 presents the subscription product recommendations generated by recommendation API 806 to the user 802 in one or more recommendation viewing GUI screens 820, and the user 802 selects a subscription product plan for enrollment 822. In some examples, the enrollment system 804 saves the enrollment selections 824, and recommendation API 806 creates an enrollment data structure associated with the user selections 826. In some examples, the plan selected for enrollment can be flagged in data structure 600 (FIG. 6) as the selected plan.

Although illustrated in a particular series of events, in other implementations, the steps of the subscription product recommendation process 800 may be performed in a different order. Additionally, in other embodiments, the subscription product recommendation process 800 may include more or fewer steps while remaining within the scope and spirit of the subscription product recommendation process 800. For example, the method 800 may not include one or more of the user input submissions (808, 810, 812, 814). Additionally, the method 800 may be adapted for a batch recommendation process where recommendations are generated at a single session for multiple members in a member population.

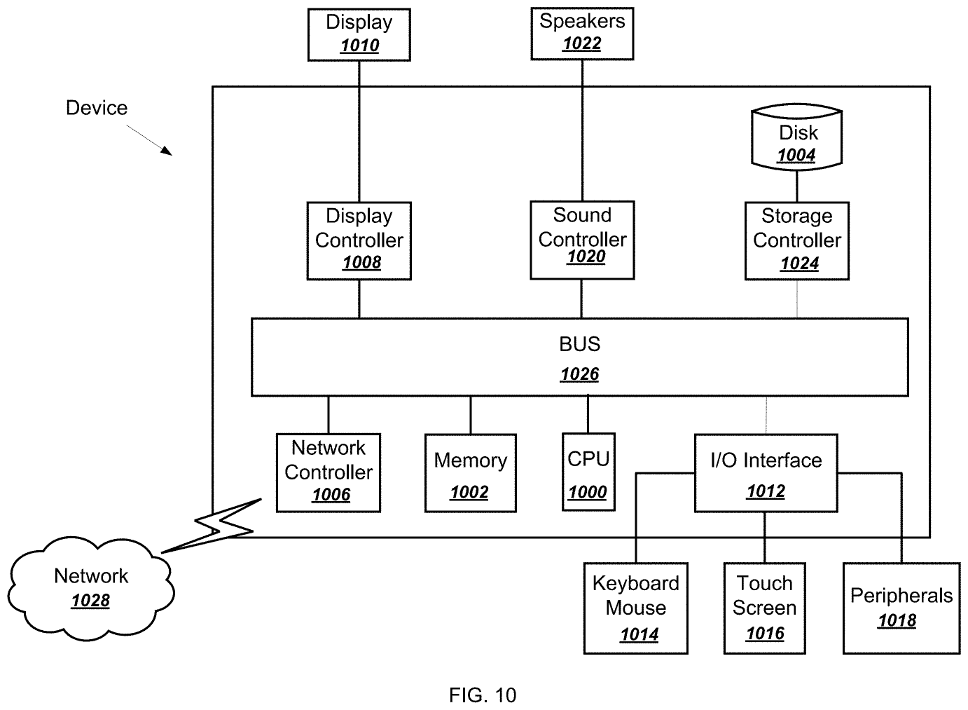

Next, a hardware description of a computing device, mobile computing device, or server according to exemplary embodiments is described with reference to FIG. 10. The hardware, in some examples, can describe broker devices 104, provider devices 106, and one or more computing devices implementing the engines of the benefits administration system 102 of FIG. 1. In further examples, the hardware description may be applicable to training/pre-scoring platform 202, online processing platform 204, and/or backend processing platform 206 as described in FIG. 2. Additionally, computing devices and systems associated with benefits administration system 300 described in FIG. 3 may be implemented using one or more computing devices as described below. In FIG. 10, the computing device, mobile computing device, or server includes a CPU 1000 which performs the processes described above. The process data and instructions may be stored in memory 1002. These processes and instructions may also be stored on a storage medium disk 1004 such as a hard drive (HDD) or portable storage medium or may be stored remotely. The data repository 112 of FIG. 1, database 310 of FIG. 3, databases 412, 424, and 432 of FIG. 4, and databases 502, 506, and 510 of FIG. 5, for example, may be implemented as one or more storage medium disks 1004. Further, the claimed advancements are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the computing device, mobile computing device, or server communicates, such as a server or computer.

Further, a portion of the claimed advancements may be provided as a utility application, background daemon, or component of an operating system, or combination thereof, executing in conjunction with CPU 1000 and an operating system such as Microsoft Windows 6, UNIX, Solaris, LINUX, Apple MAC-OS and other systems known to those skilled in the art.

CPU 1000 may be a Xeon or Core processor from Intel of America or an Opteron processor from AMD of America, or may be other processor types that would be recognized by one of ordinary skill in the art. Alternatively, the CPU 1000 may be implemented on an FPGA, ASIC, PLD or using discrete logic circuits, as one of ordinary skill in the art would recognize. Further, CPU 1000 may be implemented as multiple processors cooperatively working in parallel to perform the instructions of the inventive processes described above. In some examples, the processing circuitry of the CPU 1000 (e.g., one or more processors such as the CPU 1000) may execute instructions for performing the algorithms and methods described in relation to the engines 116, 118, 120, 122, 124, 126, 128, 130, 132, 134, 136, and 138 of FIG. 1, as well as the platforms 202, 204, and of FIG. 2 and recommendation engine 402 and enrollment system 406 of FIGS. 4 and 5. Further, the processing circuitry of the CPU 1000 (e.g., one or more processors such as the CPU 1000) may execute instructions for enabling the interfaces and communications described in relation to the recommendation API 806 of FIG. 8. Further, the processing circuitry of the CPU 1000 (e.g., one or more processors such as the CPU 1000) may execute instructions for performing the algorithms and methods described in relation to the workflow 300 of FIG. 3.

The computing device, mobile computing device, or server in FIG. 10 also includes a network controller 1006, such as an Intel Ethernet PRO network interface card from Intel Corporation of America, for interfacing with network 1028. As can be appreciated, the network 1028 can be a public network, such as the Internet, or a private network such as an LAN or WAN network, or any combination thereof and can also include PSTN or ISDN sub-networks. The network 1028 can also be wired, such as an Ethernet network, or can be wireless such as a cellular network including EDGE, 3G, 4G, or 5G wireless cellular systems. The wireless network can also be Wi-Fi, Bluetooth, or any other wireless form of communication that is known.

The computing device, mobile computing device, or server further includes a display controller 1008, such as a NVIDIA GeForce GTX or Quadro graphics adaptor from NVIDIA Corporation of America for interfacing with display 1010, such as a Hewlett Packard HPL2445w LCD monitor. A general purpose I/O interface 1012 interfaces with a keyboard and/or mouse 1014 as well as a touch screen panel 1016 on or separate from display 1010. General purpose I/O interface also connects to a variety of peripherals 1018 including printers and scanners, such as an OfficeJet or DeskJet from Hewlett Packard. Display technology 1008, 1010 and I/O peripherals 1014, 1016, and 1018 may be used, for example, to allow recommendation engine 402 and/or enrollment system 406 of FIGS. 4 and 5 to interact with the remainder of the system. The providers 106, brokers 104, and members 108 of FIG. 1 may interact with the benefits administration system 102 through display technology 1008, 1010 and I/O peripherals 1014, 1016, and 1018. In some examples, the user interfaces generated by GUI engine 132 may be rendered using display technology 1008, 1010, and user inputs and questionnaire responses may be entered via the user interfaces using I/O peripherals 1014, 1016, and 1018.

A sound controller 1020 is also provided in the computing device, mobile computing device, or server, such as Sound Blaster X-Fi Titanium from Creative, to interface with speakers/microphone 1022 thereby providing sounds and/or music.

The general-purpose storage controller 1024 connects the storage medium disk 1004 with communication bus 1026, which may be an ISA, EISA, VESA, PCI, or similar, for interconnecting all of the components of the computing device, mobile computing device, or server. A description of the general features and functionality of the display 1010, keyboard and/or mouse 1014, as well as the display controller 1008, storage controller 1024, network controller 1006, sound controller 1020, and general purpose I/O interface 1012 is omitted herein for brevity as these features are known.

One or more processors can be utilized to implement various functions and/or algorithms described herein, unless explicitly stated otherwise. Additionally, any functions and/or algorithms described herein, unless explicitly stated otherwise, can be performed upon one or more virtual processors, for example on one or more physical computing systems such as a computer farm or a cloud drive.

Reference has been made to flowchart illustrations and block diagrams of methods, systems and computer program products according to implementations of this disclosure. Aspects thereof are implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

Moreover, the present disclosure is not limited to the specific circuit elements described herein, nor is the present disclosure limited to the specific sizing and classification of these elements. For example, the skilled artisan will appreciate that the circuitry described herein may be adapted based on changes on battery sizing and chemistry or based on the requirements of the intended back-up load to be powered.

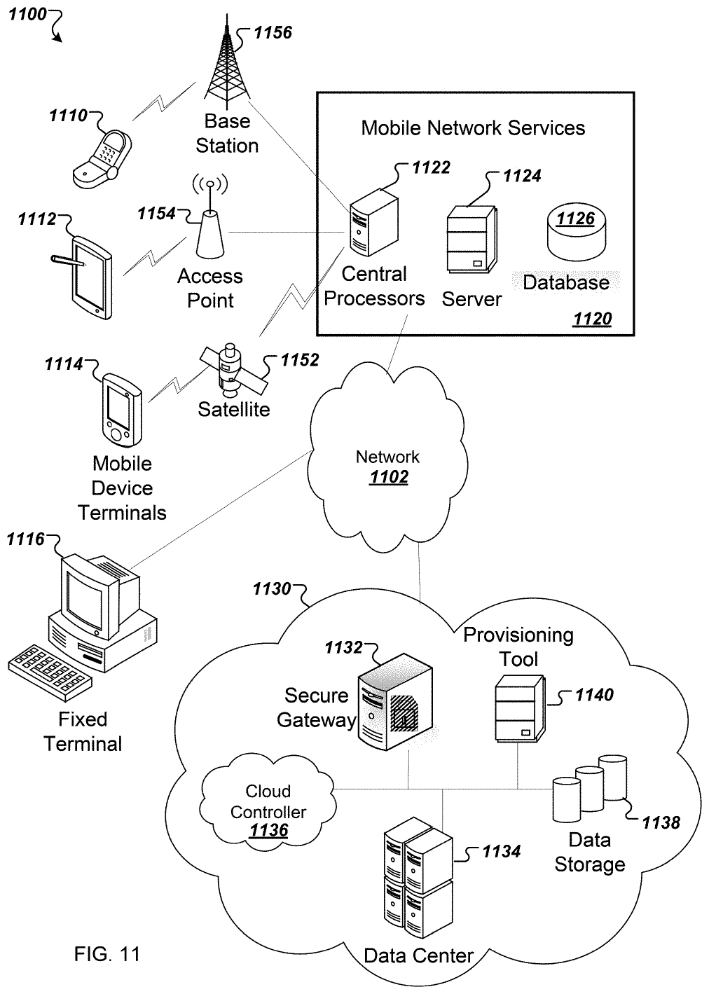

The functions and features described herein may also be executed by various distributed components of a system. For example, one or more processors may execute these system functions, where the processors are distributed across multiple components communicating in a network. The distributed components may include one or more client and server machines, which may share processing, as shown on FIG. 11, in addition to various human interface and communication devices (e.g., display monitors, smart phones, tablets, personal digital assistants (PDAs)). The network may be a private network, such as a LAN or WAN, or may be a public network, such as the Internet. Input to the system may be received via direct user input and received remotely either in real-time or as a batch process. Additionally, some implementations may be performed on modules or hardware not identical to those described. Accordingly, other implementations are within the scope that may be claimed.

In some implementations, as illustrated in FIG. 11, the innovations described herein may interface with a cloud computing environment 1130, such as Google Cloud Platform™ or Amazon Web Services™ to perform at least portions of methods or algorithms detailed above. For example, the benefits administration system 102 and engines thereof may be implemented in a distributed cloud computing environment, accessed via a network by the members 108, brokers 104, and providers 106. Further, a portion of the elements of FIGS. 2-5, 8, and 9A-9C may be implemented in a distributed cloud computing environment. The processes associated with the methods described herein can be executed on a computation processor, such as the Google Compute Engine or Amazon Elastic Container Service by data center 1134 (e.g., similar to the CPU 1000 of FIG. 10). The data center 1134, for example, can also include an application processor, such as the Google App Engine, that can be used as the interface with the systems described herein to receive data and output corresponding information. The cloud computing environment 1130 may also include one or more databases 1138 or other data storage, such as cloud storage and a query database. For example, the data repository 112 of FIG. 1, database 310 of FIG. 3, databases 412, 424, and 432 of FIG. 4, and databases 502, 506, and 510 of FIG. 5 may be implemented as cloud storage. In some implementations, the cloud storage database 1138, such as the Google Cloud Storage, may store processed and unprocessed data supplied by systems described herein.

The systems described herein may communicate with the cloud computing environment 1130 through a secure gateway 1132. In some implementations, the secure gateway 1132 includes a database querying interface, such as the Google BigQuery platform.

The cloud computing environment 1130 may include a provisioning tool 1140 for resource management. The provisioning tool 1140 may be connected to the computing devices of a data center 1134 to facilitate the provision of computing resources of the data center 1134. The provisioning tool 1140 may receive a request for a computing resource via the secure gateway 1132 or a cloud controller 1136. The provisioning tool 1140 may facilitate a connection to a particular computing device of the data center 1134.

A network 1102 represents one or more networks, such as the Internet, connecting the cloud environment 1130 to a number of client devices such as, in some examples, a cellular telephone 1110 via base station 1156, a tablet computer 1112 via access point 1154, a mobile computing device 1114 via satellite communications system 1152, and a desktop computing device 1116. The network 1102 can also communicate via wireless networks using a variety of mobile network services 1120 such as Wi-Fi, Bluetooth, cellular networks including EDGE, 3G and 4G wireless cellular systems, or any other wireless form of communication that is known. In some embodiments, the network 1102 is agnostic to local interfaces and networks associated with the client devices to allow for integration of the local interfaces and networks configured to perform the processes described herein. As illustrated in FIG. 1, a claims records network may interface with a benefits administration network (e.g., the Internet), and providers 106, members 108, and brokers 104 may each connect to the benefits administration network via a wired or wireless interface.

One or more processors can be utilized to implement various functions and/or algorithms described herein. Additionally, any functions and/or algorithms described herein can be performed upon one or more virtual processors. The virtual processors, for example, may be part of one or more physical computing systems such as a computer farm or a cloud drive.

Aspects of the present disclosure may be implemented by software logic, including machine readable instructions or commands for execution via processing circuitry. The software logic may also be referred to, in some examples, as machine readable code, software code, or programming instructions. The software logic, in certain embodiments, may be coded in runtime-executable commands and/or compiled as a machine-executable program or file. The software logic may be programmed in and/or compiled into a variety of coding languages or formats.

Aspects of the present disclosure may be implemented by hardware logic (where hardware logic naturally also includes any necessary signal wiring, memory elements and such), with such hardware logic able to operate without active software involvement beyond initial system configuration and any subsequent system reconfigurations (e.g., for different object schema dimensions). The hardware logic may be synthesized on a reprogrammable computing chip such as a field programmable gate array (FPGA) or other reconfigurable logic device. In addition, the hardware logic may be hard coded onto a custom microchip, such as an application-specific integrated circuit (ASIC). In other embodiments, software, stored as instructions to a non-transitory computer-readable medium such as a memory device, on-chip integrated memory unit, or other non-transitory computer-readable storage, may be used to perform at least portions of the herein described functionality.

Various aspects of the embodiments disclosed herein are performed on one or more computing devices, such as a laptop computer, tablet computer, mobile phone or other handheld computing device, or one or more servers. Such computing devices include processing circuitry embodied in one or more processors or logic chips, such as a central processing unit (CPU), graphics processing unit (GPU), field programmable gate array (FPGA), application-specific integrated circuit (ASIC), or programmable logic device (PLD). Further, the processing circuitry may be implemented as multiple processors cooperatively working in concert (e.g., in parallel) to perform the instructions of the inventive processes described above.

The process data and instructions used to perform various methods and algorithms derived herein may be stored in non-transitory (i.e., non-volatile) computer-readable medium or memory. The claimed advancements are not limited by the form of the computer-readable media on which the instructions of the inventive processes are stored. For example, the instructions may be stored on CDs, DVDs, in FLASH memory, RAM, ROM, PROM, EPROM, EEPROM, hard disk or any other information processing device with which the computing device communicates, such as a server or computer.

These computer program instructions can direct a computing device or other programmable data processing apparatus to function in a particular manner, such that the instructions stored in the computer-readable medium produce an article of manufacture including instruction means which implement the function/operation specified in the illustrated process flows.

Embodiments of the present description rely on network communications. As can be appreciated, the network can be a public network, such as the Internet, or a private network such as a local area network (LAN) or wide area network (WAN) network, or any combination thereof and can also include PSTN or ISDN sub-networks. The network can also be wired, such as an Ethernet network, and/or can be wireless such as a cellular network including EDGE, 3G, 4G, and 5G wireless cellular systems. The wireless network can also include Wi-Fi®, Bluetooth®, Zigbee®, or another wireless form of communication.

The computing device, in some embodiments, further includes a display controller for interfacing with a display, such as a built-in display or LCD monitor. A general purpose I/O interface of the computing device may interface with a keyboard, a hand-manipulated movement tracked I/O device (e.g., mouse, virtual reality glove, trackball, joystick, etc.), and/or touch screen panel or touch pad on or separate from the display.

Moreover, the present disclosure is not limited to the specific circuit elements described herein, nor is the present disclosure limited to the specific sizing and classification of these elements. For example, the skilled artisan will appreciate that the circuitry described herein may be adapted based on changes in battery sizing and chemistry or based on the requirements of the intended back-up load to be powered.

The functions and features described herein may also be executed by various distributed components of a system. For example, one or more processors may execute these system functions, where the processors are distributed across multiple components communicating in a network. The distributed components may include one or more client and server machines, which may share processing, in addition to various human interface and communication devices (e.g., display monitors, smart phones, tablets, personal digital assistants (PDAs)). The network may be a private network, such as a LAN or WAN, or may be a public network, such as the Internet. Input to the system, in some examples, may be received via direct user input and/or received remotely either in real-time or as a batch process.

Although provided for context, in other implementations, methods and logic flows described herein may be performed on modules or hardware not identical to those described. Accordingly, other implementations are within the scope that may be claimed.

In some implementations, a cloud computing environment, such as Google Cloud Platform™ or Amazon™ Web Services (AWS™), may be used perform at least portions of methods or algorithms detailed above. The processes associated with the methods described herein can be executed on a computation processor of a data center. The data center, for example, can also include an application processor that can be used as the interface with the systems described herein to receive data and output corresponding information. The cloud computing environment may also include one or more databases or other data storage, such as cloud storage and a query database. In some implementations, the cloud storage database, such as the Google™ Cloud Storage or Amazon™ Elastic File System (EFS™), may store processed and unprocessed data supplied by systems described herein.

While certain embodiments have been described, these embodiments have been presented by way of example only and are not intended to limit the scope of the present disclosures. Indeed, the novel methods, apparatuses and systems described herein can be embodied in a variety of other forms; furthermore, various omissions, substitutions and changes in the form of the methods, apparatuses and systems described herein can be made without departing from the spirit of the present disclosures. The accompanying claims and their equivalents are intended to cover such forms or modifications as would fall within the scope and spirit of the present disclosures.

What is claimed is:

1. A system for providing subscription product recommendations, the system comprising: software logic for executing on processing circuitry and/or hardware logic configured to perform operations comprising
identifying, by a set of trained machine learning data models, one or more cost-driving factors impacting costs of a plurality of subscription products offered by a provider, wherein
the set of trained machine learning data models are trained with claims data from a member population having two or more successive years of associated claims data for each member of the member population, and
the one or more cost-driving factors correspond to attributes of the claims data in a first year of the two or more successive years that predict future costs from the claims data in at least one next year of the two or more successive years,
receiving, from a remote computing device of a member via a network, a request for subscription product recommendations offered by the provider, the request including responses to one or more questions each associated with a factor of the one or more cost-driving factors,
mapping, based on the responses to the one or more questions, the member to a cluster grouping of a plurality of cluster groupings, wherein
each cluster grouping is defined by one or more member attributes associated with the one or more cost-driving factors, and
each cluster grouping includes a projected cost to the member associated with each of the plurality of subscription products,
determining, in real-time based on the mapping of the member to the cluster grouping, one or more subscription product recommendations for the member, and
causing presentation of, in real-time responsive to receiving the request, of a subscription product recommendation user interface screen at the remote computing device, the subscription product recommendation user interface screen presenting the one or more subscription product recommendations for viewing or selection by the member.

2. The system of claim 1, wherein the one or more cost-driving factors comprise one or more factors associated with health characteristics, chronic illness, prescription medication use, family planning, in-patient hospitalization, and/or medical treatment.

3. The system of claim 1, wherein the one or more member attributes comprise one or more attributes based on demographic information, medical history, claims data, and/or risk preferences.

4. The system of claim 1, wherein mapping the member to the cluster grouping comprises identifying, by a second set of trained machine learning data models, the cluster grouping based at least in part on the responses to the one or more questions.

5. The system of claim 4, wherein:
the second set of trained machine learning data models are trained with a set of cluster data comprising a data set of responses to the one or more questions by population members; and
each cluster grouping of the plurality of cluster groupings corresponds to attributes of the cluster data.

6. The system of claim 5, wherein:
the cluster data comprises a data set of demographic information of cluster grouping members; and
identifying the cluster grouping is based at least in part on demographic information of the member.

7. The system of claim 5, wherein determining the one or more subscription product recommendations comprises:
identifying one or more subscription products based at least in part on scoring each subscription of the plurality of subscription products for each cluster grouping of the plurality of cluster groupings, wherein
each subscription of the one or more subscription recommendations has a favorable score for the cluster grouping, and
the scoring is based at least in part on determining expected cost of each subscription to members of each cluster grouping, wherein determining the expected costs comprises
predicting, by the second set of trained machine learning data models, the expected costs based at least in part on claims data for members of the cluster group associated with each subscription, wherein
lower expected out of pocket costs of a respective subscription to members of a respective cluster grouping corresponds to a favorable score.

8. The system of claim 7, wherein determining the expected costs is based on a set of actuarial value data.

9. The system of claim 1, wherein determining the one or more subscription product recommendations comprises identifying one or more subscription products based at least in part on scoring each subscription of the plurality of subscription products for each cluster grouping of the plurality of cluster groupings, wherein
each subscription of the one or more subscription recommendations has a favorable score for the cluster grouping.

10. The system of claim 9, wherein the scoring is based at least in part on the one or more member attributes of each cluster grouping of the plurality of cluster groupings.

11. The system of claim 9, wherein the scoring is based at least in part on a determination of expected cost of each subscription to members of each cluster grouping.

12. The system of claim 11, wherein the expected cost includes expected out of pocket costs, wherein
lower expected out of pocket costs of a respective subscription to members of a respective cluster grouping corresponds to a favorable score.

13. The system of claim 1, wherein determining the one or more subscription product recommendations is based at least in part on an economic equivalent score for each of the plurality subscription products, wherein
the economic equivalent score is based on the projected cost for the respective subscription product and one or more adjustment factors indicating an impact of one or more qualitative factors on subscription product selection choices made by the member.

14. The system of claim 13, wherein determining the economic equivalent score comprises identifying, by a second set of trained machine learning data models, the projected costs of the cluster grouping wherein
the second set of trained machine learning data models are trained with a set of cluster data comprising a set of cost data, the cost data comprising actual costs incurred by members of each cluster grouping in connection with each of the plurality of subscription products.

15. The system of claim 14, wherein the projected cost includes projected out of pocket costs, wherein
lower projected out of pocket costs of a respective subscription to members of a respective cluster grouping corresponds to a favorable economic equivalent score.

16. The system of claim 13, wherein the operations comprise determining the projected costs by predicting, using the second set of trained machine learning data models, the projected costs based at least in part on claims data for members of the cluster group associated with each subscription.

17. The system of claim 13, wherein the operations comprise determining the projected costs by predicting, using the second set of trained machine learning data models, the projected costs based at least in part on a set of actuarial value data.

18. The system of claim 13, wherein the operations comprise:
determining at least a portion of the one or more adjustment factors based on one or more behavior related factors of the member; and
calculating the economic equivalent score using the projected cost for the respective subscription product and the one or more adjustment factors.

19. The system of claim 18, wherein the behavior related factors comprise one or more of plan-design preferences, risk tolerance, referral procedures, cover of supplemental care desire to purchase additional coverage, desire of having doctors in-network, or willingness to pay for higher Centers for Medicare and Medicaid Services star rating.

20. The system of claim 1, wherein:
each of the one or more cost-driving factors is applied a corresponding weighting factor in the set of trained machine learning data models; and
the operations comprise
converting, in real-time upon receipt, claims data generated from a claim submitted under a recommended subscription product into training data, and
processing the training data in the set of trained machine learning data models to validate one or more of the corresponding weighting factors.
